(19) United States
(12) Patent Application Publication
(10) Pub. No.: US 2008/0172344 A1
(43) Pub. Date: Jul. 17, 2008

(54) SOCIAL NETWORKING PLATFORM FOR BUSINESS-TO-BUSINESS INTERACTION

(76) Inventors: William Eager, Conifer, CO (US); Susan Spielman, Conifer, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/624,110

(22) Filed: Jan. 17, 2007

(51) Int. Cl. G06Q 30/00

(52) U.S. Cl. 705/80

(57) ABSTRACT

A social network for business-to-business platform using an e-commerce platform and system consolidate a tiered vertical market space by connecting multiple vendors to a target audience or consumer class through an affiliate network. In one embodiment, an affiliate network (200) includes consumer platforms (220), vendor platforms (230) and affiliate platforms (240), all connected via a social network for business-to-business platform (210). The social network for business-to-business platform (210) includes a number of web pages that may include content (213) of interest to the consumers (220), as well as a market place (212) by which consumers (220) can purchase products from the various vendors (230). In addition, consumers (220) may be referred to the platform (210) by the affiliate platforms (240). In such cases, affiliate branding information may be displayed in connection with the interfaces of the social network for business-to-business platform (210), and referral fees may be generated for the affiliates. The social network for business-to-business platform (210) may provide a variety of administrative functions, as well as generating content for use by the affiliate platforms (240).

### CROSS-REFERENCE TO RELATED APPLICATION

This application claims priority to U.S. application Ser. No. 11/553,362, entitled “AFFILIATE NETWORK E-COMMERCE SYSTEM,” filed on Oct. 26, 2006, which claims priority to U.S. Provisional Application No. 60/758,431, entitled “CATALYST HUB INTEGRATION ENGINE,” filed on Jan. 11, 2006, the contents of both of which are incorporated herein as if set forth in full.

### FIELD OF INVENTION

The present invention relates in general to a social networking infrastructure and associated e-commerce sites or platforms, e.g., accessible via the internet, and in particular to a social networking platform, and associated structure and methodology, for consolidating tiered vertical market spaces by connecting multiple vendors to target audiences through an affiliate network.

### BACKGROUND OF THE INVENTION

Social networking and e-commerce have become two important but, heretofore, distinct applications of the internet. Social networking is a combination of relatively new technologies, and social practices, that allow for individuals to expand their spheres of personal and professional connections through online interactions. For example, an individual may register with one or more social networking sites to establish groups of friends or others with common interests to facilitate social interaction. In some case, such social networking sites are used to expand an individual's base of business contacts that may advance that individual's career. In any event, such social networking sites have been viewed as a tool to advance social interaction between individuals or groups of individuals, whatever their particular goals might be. Generally, e-commerce refers to commercial transactions that are consummated electronically, e.g., via the internet or through other communication mechanisms such as a private network for mobile devices. For example, it is now common for consumers to search for products of interest on-line. Once a suitable site has been identified, the consumer can select products to be added to a “cart.” The consumer can continue to add items to the cart until all products of interest available via the site have been selected. The consumer can then execute a check-out process, which may involve directly or indirectly entering delivery address and payment information. The order is then generally fulfilled by a vendor who attends to delivery of the products to the specified delivery address.

Early e-commerce activities were typically limited to direct transactions between a vendor (manufacturer or retailer) and a consumer. More recently, some e-commerce sites have begun to function as portals or transaction clearinghouses. That is, a consumer can use such portal sites to purchase a variety of products from a variety of vendors. Thus, a consumer might visit a portal site to purchase a book, some pillows and a pair of shoes. This has been promoted to consumers as a convenience in that consumers can take advantage of one stop shopping. The early success of some of these sites has persuaded many vendors to partner with the sites. Meanwhile, sustaining growth has required the portals to continually expand the group of vendor partners and range of product offerings.

While the portal site functions as a clearinghouse for transactions in this model, it is noted that network remains essentially a vendor-consumer marketplace, generally without the participation of any third parties. Indeed, the absence of third parties, intermediaries or affiliates has been asserted as an important efficiency of the e-commerce model. The portal site has the potential to provide business services, such as resource sharing, that become more powerful to all businesses participating in various vertical market spaces.

### SUMMARY OF THE INVENTION

The present inventors have recognized that social networking and e-commerce, previously distinct if not conflicting applications, can be combined to provide great advantages to businesses and their customers. In this regard, the inventors have recognized that conventional e-commerce models do not address certain needs of consumers, vendors and other interested parties. For example, with portal sites perpetually expanding their vendor partners and product offerings, visitors to these sites are sometimes exposed to a bewildering array of options that can make the process of identifying products of interest quite difficult. But perhaps more fundamentally, it has been recognized that the two-party market model, which has been the cornerstone of e-commerce, fails to fully take advantage of the potentially complementary business relationships of tiered vertical market spaces; or potential market spaces where the owners of market spaces share information, resources, vendors, products, advertisers, networks and customers to the benefit of all parties. The business-to-business aspect of the relationship between the various market spaces has previously been ignored in the social networking arena. The business as an entity, communicating and participating in business social network has not previous been explored. Indeed, in the business world the business model of competition with other parties is the norm. This invention not only challenges this model; it also provides mechanisms whereby businesses encounter both social networking and economic benefits through a shared network approach.

Some examples illustrate such tiered market spaces and the potentially complementary relationships in such spaces. One example of a tiered market space is fitness or wellness industries as exemplified by the yoga industry. This industry may be conceptualized as including vendors of yoga related products (e.g., yoga mats, books, videos, and complementary health and spiritual products), service providers such as yoga studios, and consumers such as students and practitioners. Other examples of tiered vertical markets include the bicycle industry (which involves, among other things, manufacturers, bike shops and consumers) and the real estate industry (which involves sellers, real estate agents, related service providers, vendors of home products such as appliances, and buyers).

It will be appreciated that the conceptualization of the number of tiers and the vertical relationship of such tiers is somewhat flexible. Regardless of the conceptualization, complementary business interests result from a common target consumer class and/or unifying subject matter. Thus, in the yoga industry example, students of local yoga studios are likely purchasers of yoga related products and vice versa. Bicycle manufacturers may benefit from the presence of local bike shops who can provide expertise and test-rides, while bike shops may have the opportunity to sell accessories and services to end users of bicycles. This social relationship between vendors can become a valuable asset to other businesses participating in the social network.

Therefore this invention presents the opportunity for the individual business/market space to itself benefit from the capability to connect multiple vendors to an affiliate-based collective (i.e. yoga studios and their customers, bike stores and their customers, etc.) and simultaneously the opportunity for the individual business/market space to benefit from the capability to connect with and share vendors, products, advertisers and even customers with other individual businesses and market places who connect with and use the social networking platform for business-to-business trading purposes. In other words, each “portal” becomes not only a stand-alone business entity, but rather an entity that is connected to and can benefit from the larger network of portals /market spaces. Further, the economic benefits of sharing information, resources, vendors, products and customers is inherent in the unique functionality and processes of the invention.

While these potentially complementary relationships may be observed by perceptive analysts, in some cases, these parties may not be organized in any meaningful way to define a market space where the potentially complementary relationships can be realized. In any event, such market spaces generally have not been realized in the e-market context where the reigning paradigm is direct vendor-consumer transactions.

The present invention addresses these needs and objectives by providing a social networking business-to-business environment where an e-commerce platform or system and associated functionality consolidates an existing or potentially tiered vertical market space by connecting multiple market spaces/portals and their vendors and products to a target audience or consumer class through an affiliate network. In this manner, market spaces/portals (e.g. bike market space or yoga market space); affiliates (e.g., bike shops or yoga studios) and vendors (manufacturers or sellers of bicycles or yoga-related products) can be linked to an e-commerce platform in a manner that promotes realization of potentially complementary relationships. For example, the market spaces/portals may contain vendors and products that are complementary such as, in the case of a bike market space and yoga market space, an energy bar vendor/product or a sports drink vendor/product. Further, the affiliate network (bike stores, yoga studios) can drive e-commerce traffic to the e-commerce platform where vendors' products and/or services are available. Affiliates can receive content from the e-commerce platform, for example, related to the relevant industry (e.g., bike training tips, yoga educational materials and spiritual resources or information about mortgage options, interest rates or mortgage calculators, etc.). Such content may expedite affiliate site construction, and enhance the value of the affiliate site to their customer base. Additionally, when consumers are referred (e.g., linked) to the market space/portal/e-commerce site by a referring affiliate, affiliate branding may be included in connection with the e-commerce platform, and referral fees may be provided to the affiliate, thereby generating a further revenue stream for the affiliate. Consumers benefit from enhanced site content, exposure to complementary products and services of likely interest, and one-stop shopping without the bewildering array of unrelated options. Businesses can participate on many levels in the manner and options in which they choose to share resources. For example, the social network can facilitate sharing of vendor relationships, services provided (such as banking or merchant accounts), customer mailing lists, and production. There is an unlimited set of resources that can be established for a business-to-business relationship enhanced through the social network established by the invention.

The social networking business-to-business platform provides functionality that can increase traffic and visibility of the affiliate web site. Specifically, any number of Internet domain names owned by the social networking business-to-business platform user which may, but do not have to be, directly relevant to the vertical market space (i.e., for the yoga industry example, www.heropose.com, www.childrensyogastie.com, www.yogafortheworld.com, etc.; for the bike industry example, www.theworldofbikes.com, www.bikeracing.com etc.) can be entered into the system. Any new affiliate is automatically listed and linked on these Internet domain name pages/web sites. This can improve visibility and traffic to the affiliate's web site by a targeted set of consumers in the vertical market. It will be appreciated that increasing the number of domain names associated with a site increases the likelihood of the site being found by relevant users. Indeed, users frequently simply type domain names in their browsers which they feel are related to their topic of interest. The present invention automates this process of listing multiple domain names and linking the names with affiliate web sites in a vertical market.

In accordance with one aspect of the present invention, a method and apparatus (“utility”) is provided related to operation of a social networking business-to-business platform with an affiliate network. The utility involves identifying a tiered vertical market defined by a market space where the tiered vertical market includes vendors of products and/or services within the market space, consumers of the products and/or services and potential affiliates having a business interest complementary to an industry of the market space. The utility further involves establishing a social networking business-to-business platform that can be linked to affiliate platforms of the potential affiliates and to vendor platforms of the potential vendors and linking the e-commerce platform to a number of the affiliate platforms and a number of the vendor platforms. The social networking business-to-business platform is then operative for receiving an order including product order information from one of the consumers where the order is directed to the social networking business-to-business platform via a referring affiliate platform. The product order information identifies for purchase one or more of the products or services from one or more of the linked vendors. The social networking business-to-business platform is further operative to communicate with the referring affiliate platform and/or one of the linked vendors in relation to fulfillment of the order. For example, the social networking business-to-business platform may transmit order information to all appropriate vendors and may communicate (e.g., immediately or periodically) account information to the referring affiliate platform regarding remuneration to the referring affiliate associated with the order.

In accordance with another aspect of the present invention, a utility is provided related to operation of an affiliate platform in connection with an affiliate network as part of the social networking business-to-business platform. The utility involves operating an affiliate platform to access a social networking business-to-business platform of an affiliate network and establish a link between the platforms. For example, the affiliate platform may be operated to execute an affiliate registration process in this regard. The affiliate platform can then be operated to communicate with the social networking business-to-business platform. A variety of such communications may occur. For example, the affiliate platform may communicate branding information to the social networking business-to-business platform and/or receive content, such as affiliate branded content, from the social networking business-to-business platform. Moreover, the affiliate platform may refer a consumer to the social networking business-to-business platform.

In accordance with a further aspect of the invention, a utility is provided related to operation of a vendor platform in connection with an affiliate network. As discussed above, the vendor platform is associated with a vendor of specialty products that can be marketed to consumers via a social networking business-to-business platform of an affiliate network. The utility involves operating the vendor platform to access the social networking business-to-business platform and establish a link between the vendor platform and the social networking business-to-business platform. The vendor platform can then be operated to communicate with the social networking business-to-business platform, e.g., in relation to one or more transactions involving products of the vendor. For example, the vendor platform may transmit product offering and/or availability information to the social networking business-to-business platform. Additionally or alternatively, the vendor platform may receive order information, account information and the like from the social networking business-to-business platform. Vendors, their products and associated revenue streams from sales may be shared among businesses who use the social networking business-to-business platform for the creation of discrete market spaces/portals.

In accordance with a still further aspect of the present invention, a utility is provided related to operation of a consumer platform (e.g., a desktop or laptop computer or other mobile devices) in connection with an affiliate network. The utility involves accessing the social networking business-to-business platform and accessing an affiliate platform associated with the social networking business-to-business platform. These accessing operations may be performed in any order. For example, the consumer may access the affiliate site and then use a link associated with the affiliate platform to access the social networking business-to-business platform. Conversely, the consumer may access the social networking business-to-business platform and then link to the affiliate platform. The utility further involves submitting product order information via the social networking business-to-business platform, where the product order information identifies one or more products of one or more of the linked vendors.

In accordance with another aspect of the present invention, branding information (e.g., a trademark or other identifying information) is exchanged between platforms of an affiliate network so as to enable co-branding of site content. As discussed above, the affiliate network includes vendors, consumers and affiliates integrated with respect to a social networking business-to-business system. It is noted that conventional e-commerce systems, e.g., portal sites with a number of partnering vendors, may identify the vendor source of products, but generally do not involve co-branding of vendor sites or allow vendors to co-brand content at the e-commerce site. Indeed, because the business models of such conventional e-commerce site are largely dependent on drawing traffic to, and retaining traffic on, such sites, there is a significant incentive to uniquely impress the e-commerce site identity upon visitors, and not cultivate a multi-entity network identification. The social networking business-to-business platform allows for this conventional model to be greatly expanded in such a way that has not been previously possible.

By contrast, in connection with a social networking business-to-business affiliate network as contemplated by the present inventors, co-branding of content and exchanging branded content is accommodated and encouraged. For example, upon referral of a consumer from an affiliate platform to the social networking business-to-business platform, affiliate branding information may be displayed in connection with the social networking business-to-business platform, e.g., indicating that the social networking business-to-business platform is “being brought to you” by the referring affiliate. Conversely, the affiliate platform may be labeled as being “powered by” the social networking business-to-business platform. As a further example, content downloaded to an affiliate platform by the social networking business-to-business platform may be branded with branding information of the affiliate. In such cases, a corresponding utility involves exchanging branding information between platforms of an affiliate network, and, based on the exchanged branding information, providing content identified by the exchanged branding information at one of the platforms.

In accordance with another aspect of the present invention, location-specific information is provided to consumers via an affiliate network. In the conventional direct consumer-vendor e-commerce paradigm, the location of the consumer is generally given little consideration. However, in the context of a social networking business-to-business platform, it has been recognized that location information may be useful to identifying local affiliates, events and other items of interest. The present aspect of the invention uses consumer location information to provide local information not available via conventional e-commerce systems. A corresponding utility involves: establishing a social networking business-to-business platform in connection with an affiliate network; obtaining, via the social networking business-to-business platform, consumer identification information and consumer location information regarding a consumer; and using the consumer location information to provide location specific information to the consumer. For example, a consumer having an interest in the market space targeted by the social networking business-to-business platform may register to receive a newsletter and, in connection with such a registration process, may provide location information such as an address, city or zip code. The social networking business-to-business system may then provide affiliate contact information, event information or other information based on the consumer's location for any related information maintained in the social networking business-to-business platform that consumer has an interest in and is made available throughout the network.

In accordance with a still further aspect of the present invention, an affiliate network is used to enable targeted advertising. It will be appreciated that some portal sites have become so generalized with respect to product offerings as to significantly impair the ability of advertisers to obtain targeted commercial impressions. By contrast, the very nature of an affiliate network draws consumers having a common interest and, in some cases, additional common demographic classifications. Moreover, as noted above, location information can be associated with at least some consumers of an affiliate network (e.g., based on a newsletter registration or transaction-related information). The affiliate network thus provides enhanced opportunities for targeted advertising. An associated utility involves: establishing an affiliate network that is part of the social networking business-to-business platform related to a defined industry; providing an advertisement in connection with one or more platforms of the affiliate network; and billing for delivery of the advertisement based on targeted commercial impressions. For example, such billing may be based on visits to the one or more platforms and/or clicks on the advertisement.

### BRIEF DESCRIPTION OF THE DRAWINGS

For a more complete understanding of the present invention and further advantages thereof, reference is now made to the following detailed description, taken in conjunction with the drawings, in which:

FIG. 1 illustrates a number of market spaces organized in accordance with the present invention;

FIG. 2A is a schematic diagram of an affiliate network in accordance with the present invention;

FIG. 2B illustrates the social networking business-to-business platform environment of the present invention;

FIG. 2C illustrates the interconnected nature and inherent sharing of vendors, advertisers, affiliates and customers between tiered vertical market spaces that are connected via the social networking business-to-business platform.

FIGS. 4A-4E illustrate a number of sites provided in connection with a social networking business-to-business platform in accordance with the present invention;

FIG. 5 is a schematic diagram illustrating a database system associated with a social networking business-to-business e-commerce platform in accordance with the present invention; and

FIGS. 6-34 are screen shots illustrating the structure and functionality of a social networking business-to-business platform in accordance with the present invention.

### DETAILED DESCRIPTION

The present invention relates to a social networking for business-to-business platform for connecting businesses, consumers, vendors and affiliates through a network of resources. An industry or industry segment can thereby be integrated around a social networking for business-to-business platform. In the following description, the invention is set forth in the context of certain exemplary market spaces, such as the yoga industry, for purposes of illustration. However, it will be appreciated that the invention is applicable to a broad variety of market spaces and allows an unlimited number of businesses to participate in the social networking platform.

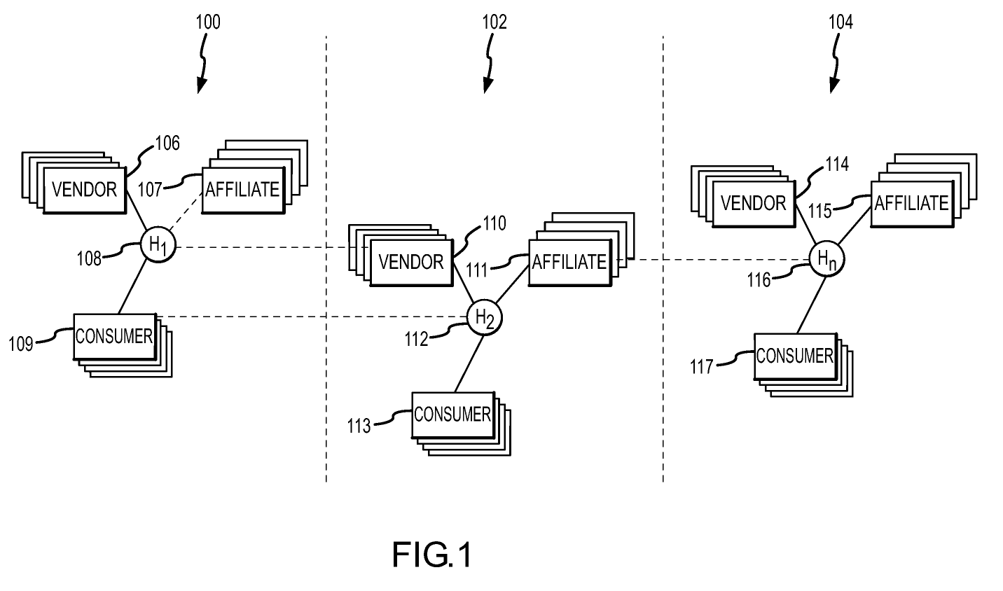

The social networking for business-to-business platform of the present invention can be used to integrate a number of market spaces. In FIG. 1, a number of market spaces participating in the social networking for business-to-business platform are generally identified by the reference numbers 100, 102 and 104. It will be appreciated that any number of market spaces may be supported in this regard. For example, the market spaces 100, 102 and 104 may comprise yoga industry, bicycle industry and real estate industry market spaces as discussed above. However, the present invention is not limited to any particular industry.

As shown in FIG. 1, the market spaces 100, 102 and 104 are integrated around hubs 108, 112 and 116. For example, these hubs 108, 112 and 116 may be e-market platforms, each of which participates in the social networking for business-to-business platform, as described in more detail below. Each hub 108, 112 or 116 connects consumers 109, 113 or 117 to vendors 106, 110 and 114 via a network that further includes a number of affiliates 107, 111 and 115. In the case of the yoga industry example, as will be discussed in considerable detail below, the vendors may be vendors of yoga related products, the consumers may be consumers of yoga related products and the affiliates may be yoga studios or others with a complementary business interest, e.g., a consumer base that overlaps that of the vendors to a significant degree. It is noted that, while it is useful to define such market spaces 100, 102 and 104, such spaces 100, 102 and 104 are generally not fully isolated from each other. Thus, for example, consumers of yoga related products may also be consumers of bicycles or the real estate industry. Similarly, a given entity may find it useful to be a part of multiple affiliate networks. For example, a fitness center or a vendor of supplements for athletes may be affiliated with a yoga industry affiliate network and a bicycle industry affiliate network. This is generally indicated in FIG. 1 by way of dashed lines extending across the various market spaces 100, 102 and 104.

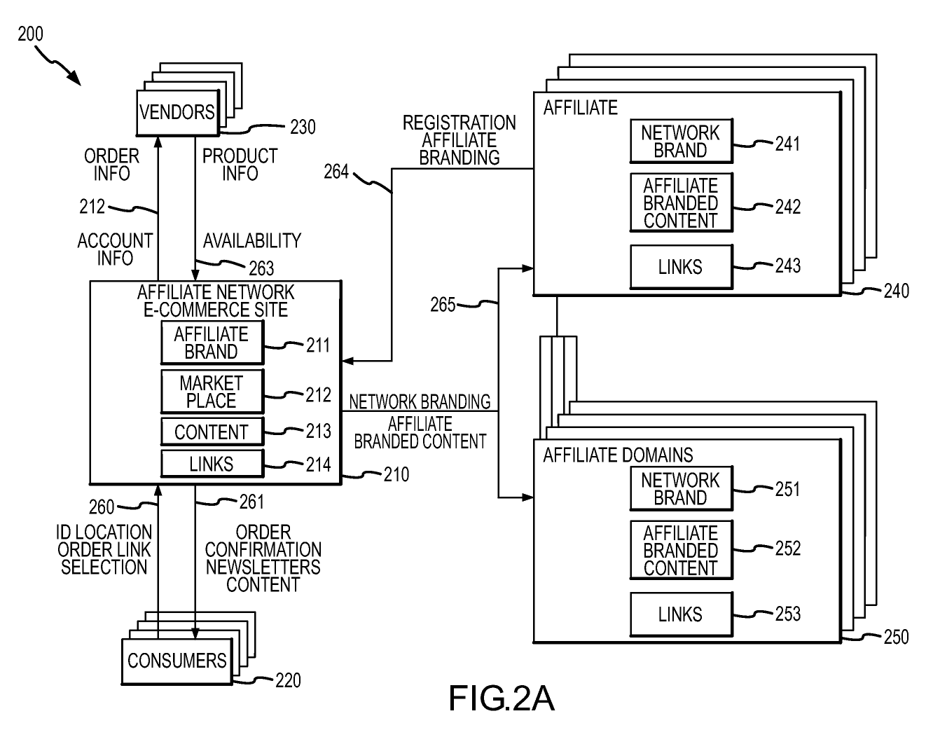

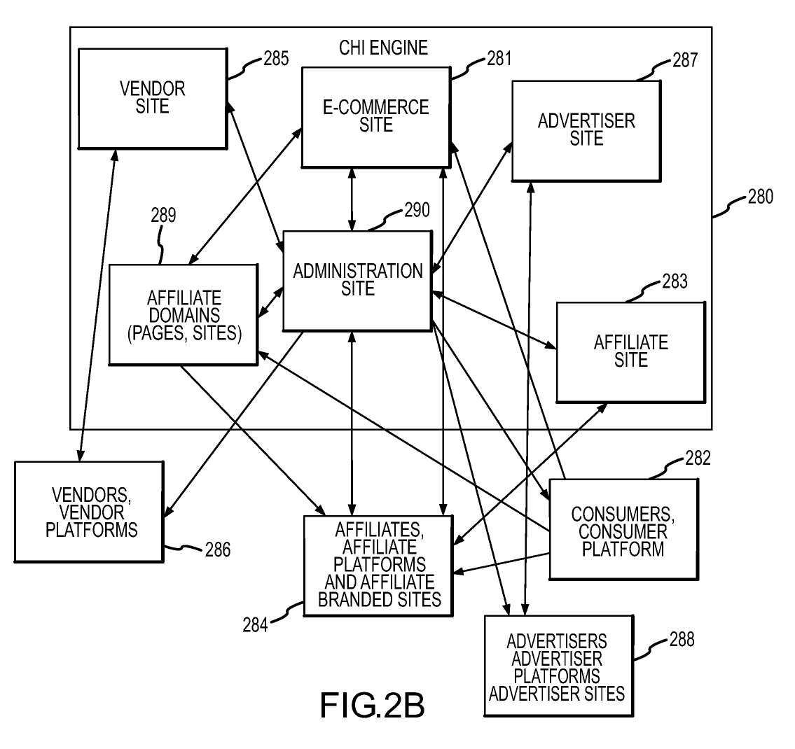

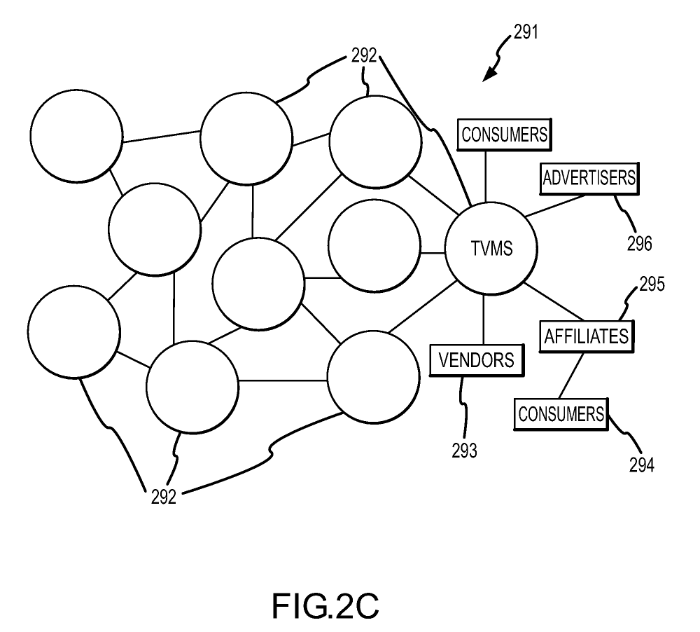

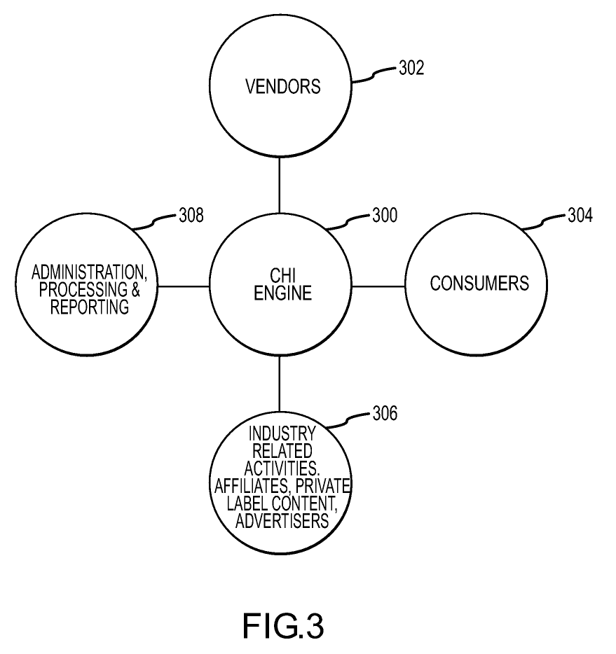

FIG. 2A further illustrates the components of a typical affiliate network 200 and examples of the types of information and links that may be shared between such components within the social networking for business-to-business platform. The illustrated network 200 includes consumer platforms 220, vendor platforms 230 and affiliate platforms 240, all interconnected via a social networking for business-to-business platform 210. The consumer platforms 220 are the data network devices used by individual consumers and may include, for example, personal computers, laptops, PDA's, data-enabled mobile phones or the like. The vendor platforms 230 may be servers or other e-commerce platforms of the individual vendors. As will be discussed in more detail below, such vendors generally register to become a part of the affiliate network 200. The platform 210 is the server or other platform used to integrate the relevant market space, as will be described in more detail below. The affiliate platforms 240 are the servers or other platforms associated with the individual affiliates. Again, the affiliates generally register to become a part of the affiliate network 200, as will be described below. Although these various platforms are referred to herein as being individual platforms, it will be appreciated that the functionality associated with any one of these platforms may be spread across multiple machines at multiple locations and across multiple social networking for business-to-business platforms as will be readily appreciated by those skilled in the field.

The illustrated social networking for business-to-business platform 210 includes a number of web pages that may include content 213 of interest to the consumers 220, as well as a marketplace 212 by which consumers 220 can purchase products from the various vendors 230. In addition, the platform 210 may include a number of links 214 of potential interest to the consumers 220, such as links to the affiliate platforms 240. In addition, the links 214 may provide information about events of interest, educational materials, communications from vendors and/or customers and/or affiliates and/or businesses, newsletter registration pages and the like.

In a preferred implementation of the present invention, branding information may be shared between one or more of the platforms 210, 230 and 240 of the affiliate network 200 and across the social networking for business-to-business platform. In this manner, a network identity is cultivated. In this regard, the social networking for business-to-business platform 210 further includes affiliate brand information 211. Thus, for example, when a consumer is referred to the social networking for business-to-business platform 210 from an affiliate platform 240, individual web pages of the platform 210 may display affiliate branding information such as, “Brought to you by [affiliate name]” and include test, graphics, multimedia or other content that brands the e-commerce platform of the affiliate. Similarly, when a consumer 220 visits an affiliate platform 240, individual web pages of the affiliate platform 240 may include network branding information 241 such as, “Powered by [affiliate network name].” The illustrated affiliate platform 240 thus includes network branding information 241 as discussed above, affiliate branded content 242 and links 243 all generated by platform and contained within the social networking for business-to-business platform.

One of the advantages of the network 200 for affiliates is the opportunity to obtain affiliate branded content 242 from the social networking for business-to-business platform 210. Thus, content may be pushed to the affiliate platform 240, or otherwise obtained at the affiliate platform 240 from the social networking for business-to-business platform 210. This content may be branded with the affiliate branding information. In this manner, affiliates can quickly populate an affiliate web site with high quality information of likely interest to consumers 220 of the network 200. The illustrated affiliate platform 240 further includes links 243, including, for example, links to other platforms of the affiliate network 200, as well as to other sites of likely interest to the consumers 220.

Another benefit of the social networking for business-to-business platform 210 is the opportunity for affiliates to automatically be listed and linked on multiple domains that are connected via the social networking for business-to-business platform using an administration site and may have, but are not required to have, intrinsic value and recognition as part of the tiered vertical market (i.e. http://www.heropose.com for a yoga implementation); and may have, but are not required to have, content that has value for the consumers in the tiered vertical market (i.e., content about how to perform a specific yoga pose). The social networking for business-to-business platform 210 allows a domain, registered and owned by the social networking for business-to-business platform operator, to be populated with high quality, relevant content or no content at all. The operator might simply want to associate the domain to the social networking for business-to-business platform. Thus, the illustrated network 200 enables affiliates to have a more effective internet presence, in addition to a variety of other advantages, as will be discussed in more detail below. In the illustrated implementation, each of the domains 250 may have network brand information 251, affiliate branded content 252 and links 253 similar to that of the affiliate platforms 240 as discussed above.

The consumer platforms 220 may provide a variety of information 260 to the social networking for business-to-business platform 210. This information may include information identifying the consumer 220, product ordering information and link selections. In addition, the present invention provides a variety of enhanced functionality based on knowing the location of individual consumers. In this regard, location information such as an address, partial address or zip code may be transmitted from the consumer platforms 220 to the social networking for business-to-business platform 210.

The consumer platforms 220 also receive a variety of information from the social networking for business-to-business platform 210. For example, the consumers may receive order confirmation information in connection with an order placed via the platform 210. In addition, the consumers may receive content made available at the social networking for business-to-business platform 210. In addition, newsletters and other information may be transmitted to the consumer platforms 220 from the platform 210 and/or the consumer platform may transmit information to the social networking for business-to-business platform. For example, a web log (blog) may be integrated within the system.

The vendor platforms 230 may receive a variety of information 262 from the social networking for business-to-business platform 210, such as order information and account information. For example, when a customer places an order via the social networking for business-to-business platform 210 for multiple products from multiple vendors, the platform 210 may transmit the relevant order information to each of the relevant vendor platforms 230. The social networking for business-to-business platform 210 can then be used as a clearinghouse to collect payments for orders. Consequently, the social networking for business-to-business platform 210 keeps account of payments due to the various vendors. Related account information and payments may be transmitted periodically to the vendor platforms 230 or the vendor platforms 230 may be operated to access account information from the social networking for business-to-business platform 210.

The vendor platforms 230 also provide a variety of information 263 to the platform 210. For example, this information 263 may include product information and product availability information. Thus, it will be appreciated that product information is provided to the social networking for business-to-business platform 210 in order to allow the platform 210 to provide information about available products to consumers visiting the site 210. The vendor platforms 230 may further transmit order availability information (available, back-ordered, etc.) sua sponte or in response to receiving order information from the social networking for business-to-business platform 210.

The affiliate platforms 240 may transmit a variety of information 264 to the social networking for business-to-business platform 210. This information may include number of consumers visiting the social networking for business-to-business platform via the affiliate platform, consumer 220 and product ordering data at the time of a sale in the social networking for business-to-business platform, registration information and affiliate branding information. With regard to registration information, as noted above, affiliates generally register to be included in the affiliate network 200. Moreover, as discussed above, an advantage of the affiliate network 200 for affiliates is that affiliate brand information 211 may be displayed in connection with the social networking for business-to-business platform 210 at least in events where consumers are referred to the social networking for business-to-business platform 210 from an affiliate platform 210. Moreover, affiliates can receive affiliate branded content 242 from the social networking for business-to-business platform 210. In this regard, affiliate branding information may be uploaded to the social networking for business-to-business platform 210 from the affiliate platforms 240 to enable such functionality.

In addition, a variety of information 265 may be transmitted from the social networking for business-to-business platform 210 to the affiliate platforms 240 and affiliate domains 250. As discussed above, network branding information 241 and 251 may be displayed in connection with web pages at the affiliate platforms 240 and affiliate domains 250. Accordingly, network branding information may be pushed to the platforms 240 and domains 250. Additionally, affiliate branded content may be pushed from the social networking for business-to-business platforms 240 to the affiliate platforms 240 and affiliate domains 250. Additional communications may occur between the various platforms 210, 220, 230, 240 and 250. For example, a consumer may directly access a vendor platform 230, an affiliate platform 240 or an affiliate domain 250. Indeed, one of the advantages of the network 200 is that traffic is driven to the social networking for business-to-business platform 210 from at least the affiliate platforms 240 and affiliate domains 250.

At the core of the social networking for business-to-business platform in the illustrated implementation is a powerful online engine or catalyst hub integration (CHI) engine. The CHI engine enables rapid deployment of an integrated online market space for any vertical tiered market. The CHI engine seamlessly connects vendors, affiliates and consumers with content, products and advertising in a comprehensive online market space. Each vendor has access to a secure online environment to monitor and process orders and update product inventory. Customers receive automated messages regarding their orders and any back-ordered products. Affiliates receive detailed reports about both the use of the affiliate web site to send both traffic and sales to the social networking for business-to-business platform and all related earnings from this activity. All of these functions are implemented via an architecture involving object-oriented programming and an extensive library of code that can be adapted to perform common functions for each market space application. The object-oriented programming entails a number of objects that can assume attributes as required for specific market space applications. In this manner, an entire market space that connects multiple vendors, consumers and affiliates can be integrated in a matter of days.

Thus, in the embodiments discussed herein, the social networking for business-to-business platform implements the CHI engine. The CHI engine includes the logic for generating and controlling a number of sites. These sites are accessed by various parties interested in the market space, such as vendors, affiliates, consumers and advertisers.

These relationships are illustrated in FIG. 2B. As shown, the CHI engine 280 provides the embodiment of an e-commerce site 281 that can be accessed by consumers 282 using consumer platforms, for example, to shop for products or obtain information. It will be appreciated that this site may be presented to consumers differently (e.g., with or without affiliate branding) depending, for example, on whether the site was accessed directly or via an affiliate platform. The engine 280 further provides an affiliate site 283 that can be accessed by affiliates 284 associated with affiliate platforms and affiliate platform sites. For example, the affiliate site 283 may be accessed to upload branding information or obtain account information.

A vendor site 285, provided by engine 280, may be accessed by vendors 286 associated with vendor platforms. The vendors 286 may access the vendor site 285, for example, to provide product availability information or obtain account information. The engine 280 further provides an advertiser site 287 that may be accessed by advertisers 288 associated with advertiser platforms and advertiser platform sites. The advertisers 288 may access the advertiser site 287, for example, to upload ad copy or obtain up-to-date campaign information.

The illustrated engine 280 further establishes and supports affiliate domains that can be used to drive consumers to affiliate platforms. For example, a substantial list of affiliate domains may be compiled for a given market space, and those domains may be linked to affiliates to increase affiliate platform traffic. The administration site 290, provided by engine 280, is a central point where connections between the various parties are established; content, advertising, products and payments are managed and activities reported.

With regard to FIG. 2B, it is noted that while most interactions are two-way in nature, some, such as consumers moving to domain name pages, then to affiliate branded sites, are one-way flows. Consumers may flow seamlessly back and forth between either affiliate branded sites and the e-commerce site or between domain name pages and the e-commerce site or between other e-commerce sites participating in the social network for business-to-business platform. While most consumer interactions are outgoing (from the consumer), the administration site does send information to the consumer.

A social network for business-to-business interaction environment 291 is illustrated in FIG. 2C. The illustrated environment 291 includes an interconnected web of tiered vertical market spaces (TVMSs) 292. Although only shown in relation to one TVMS 202 for clarity of illustration, each TVMS 292 may include associated advertisers 296, affiliates 295, consumers 294 and vendors 293. Thus, each TVMS 292 can function as a stand-alone system or, alternatively, can share information, resources, vendors, products, advertisers, consumers, etc., with other TVMSs292

The CHI engine environment is schematically illustrated in FIG. 3. As shown, the CHI engine 300 is at the core of the environment and interconnects vendors 302 and consumers 304. The CHI engine 300 further is operative to implement industry-related activities 306, such as managing affiliate communications, pushing content to affiliate platforms and managing advertising in connection with the e-commerce sites and the social network for business-to-business platform. Finally, the CHI engine 300 handles a number of administrative functions 308, such as processing orders, managing account information and generating reports for vendors and affiliates throughout the social network for business-to-business platform.

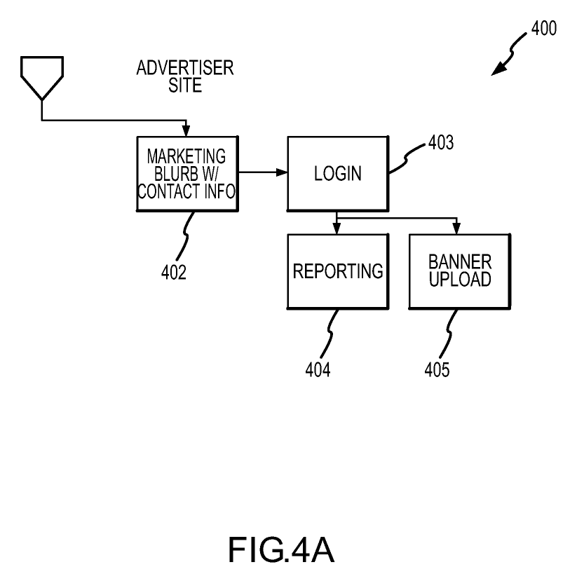

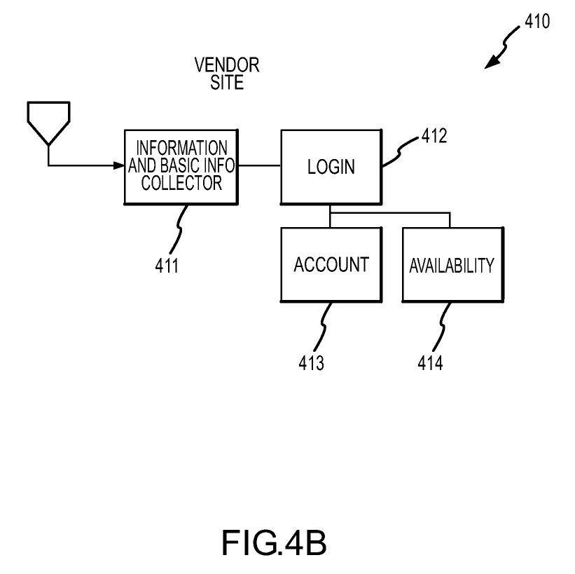

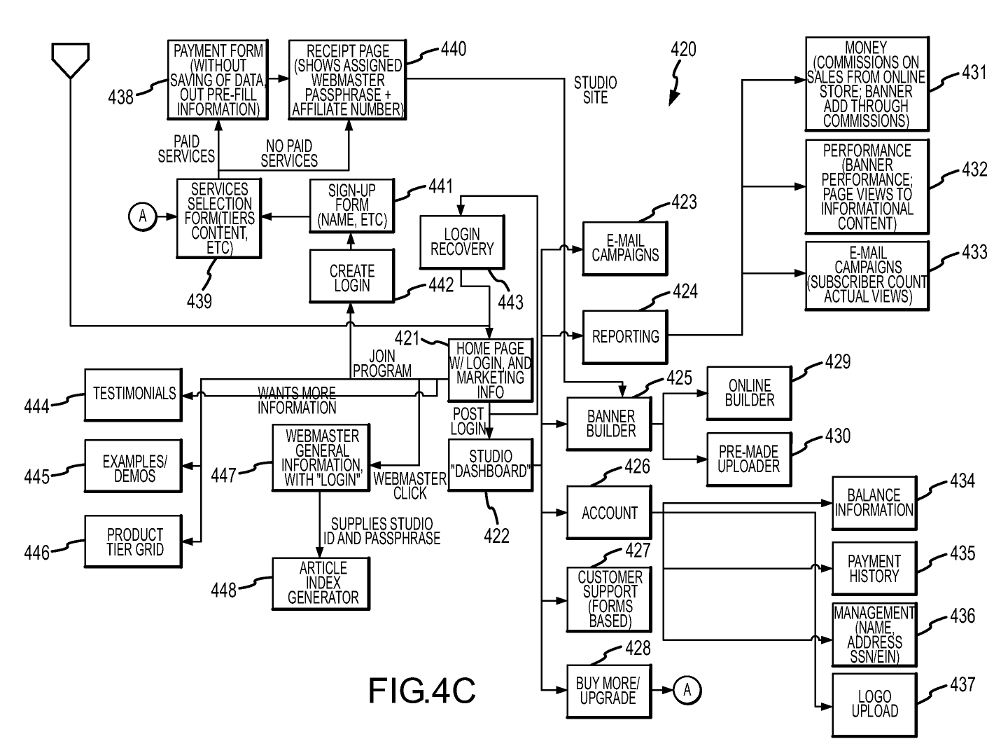

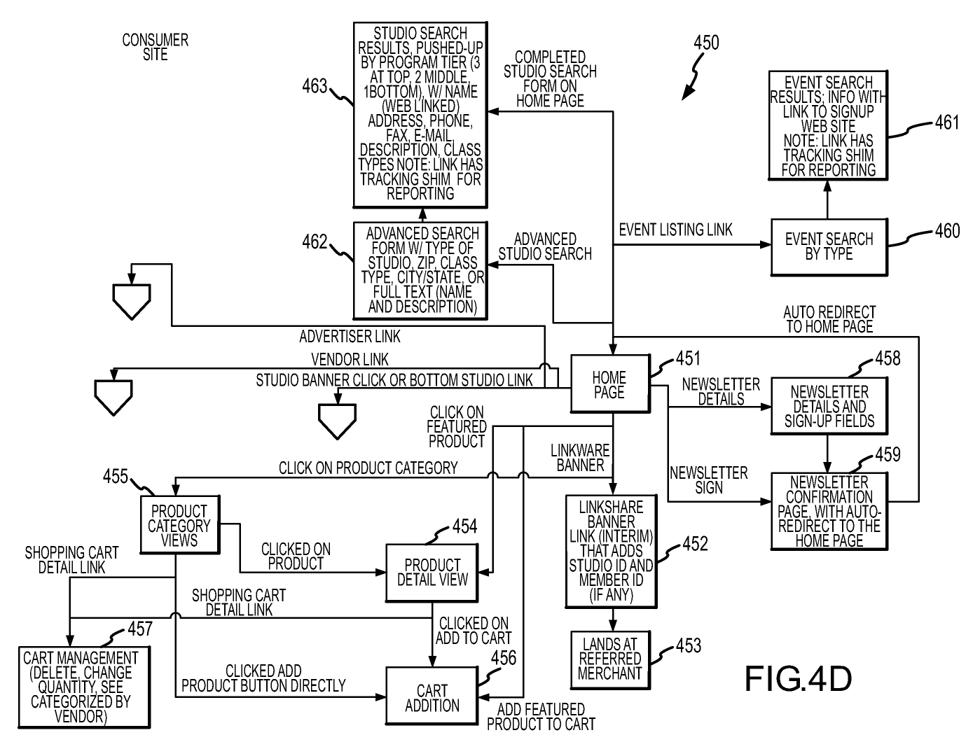

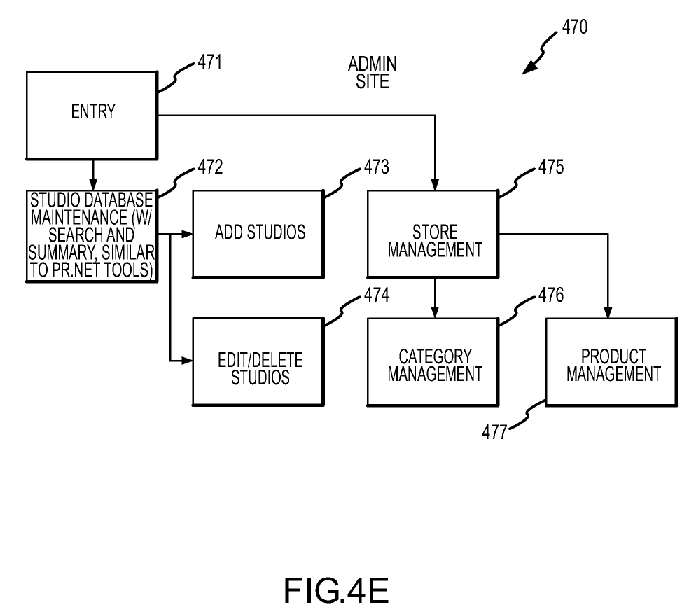

The social network for business-to-business platform, which implements the CHI engine, thus provides a number of sites, including an advertiser site, a vendor site, an affiliate site, a consumer site and an administrative site. These are graphically illustrated in FIGS. 4A-4E. FIG. 4A illustrates an advertiser site 400. The illustrated advertiser site 400 may include marketing information 402 and related contact information. For example, the marketing information may include information of interest to advertisers or potential advertisers, such as the advantages of the affiliate network environment in terms of generating targeted commercial impressions, as well as information regarding the number of visits and demographics of consumers of the relevant affiliate network. The contact information may direct advertisers to network administration personnel who can assist advertisers in designing and implementing an advertising campaign via the affiliate network. The illustrated advertiser site 400 further includes a login screen where advertisers can login to obtain secure information regarding their accounts as well as to manage accounts, add, delete or modify advertising strategies. After logging in, advertisers can obtain reporting information 404, which may include, for example, information regarding the number of targeted commercial impressions delivered, the demographics of the audience reached, advertising costs, etc. The advertisers can also access a utility 405 for uploading banners or other advertising content. It will be appreciated that the advertising content may be in the form of text, graphics, full emulsion video, sound, etc. Further, the advertiser site may connect advertisers to one or multiple tiered vertical market spaces, all managed by the CHI Engine, for direct-to-targeted-market advertising opportunities within the social network for business-to-business platform.

FIG. 4B illustrates a vendor site 410 associated with the e-commerce platform. The vendor site 410 includes an introductory page 411 where vendors or potential vendors can enter or review basic vendor information such as a vendor name, address, contact information and the like. The illustrated vendor site 410 further includes a login utility 412 that can be used to access secure information. Once a vendor is logged in via the login utility 412, the vendor can access a variety of secure information such as account information 413 and product availability information 414. For example, a vendor may review the account information 413 to obtain information about orders and pending orders. In addition, the vendor may add, delete or modify product availability information 414 for all e-commerce sites participating in the social network for business-to-business platform.

FIG. 4C illustrates an affiliate site 420, in this example, a studio site, associated with an e-commerce platform. The illustrated affiliate site 420 includes a home page 421 that may display, for example, login and marketing information. The marketing information may include any information of potential interest to affiliates such as information regarding online network traffic, network changes and promotions. The login utility can be used to enable affiliate sites to login to access secure functions. In this regard, a login recovery utility 443 handles errors in connection with the login process and assists users having difficulty with the login procedure.

Once an affiliate has logged in, the affiliate may access an affiliate dashboard 422, which provides access to a variety of functions including e-mail campaigns 423, reporting 424, a banner builder utility 425, account information 426, customer support 427 and an upgrade service 428. The e-mail campaigns 423 provide a mechanism by which affiliates can contact consumers and potential consumers with information regarding, for example, promotions and events. The reporting function 424 enables affiliates to obtain report information regarding a variety of activities such as financial information 431, performance information 432 and information regarding e-mail campaigns 433. The financial information 431 may include reports identifying commissions on sales from the e-commerce platform, banner click-through commissions in connection with a pay-per-click implementation and the like. The performance information 432 can provide various information for evaluating the performance of banner ads as well as the number of hits on various informational pages. The e-mail campaign information 433 may provide reports identifying the number of subscribers who have agreed to receive e-mail information as well as views to the underlying information from which the reports were generated.

The banner builder utility 425 can be used by affiliates to upload banner ads or other ads to the e-commerce site. In this regard, the banner builder utility 425 may include an online builder utility 429 that can be used by studio operators to build banner ads. In addition, the banner builder utility 425 may include a utility 430 for uploading pre-made banner ads or other advertisements.

The affiliate can also access account information 426, including balance information 434 regarding, for example, a balance of commissions owed to the affiliate, payment history information 435 showing payments made to the affiliate, a management utility 436 that can be used to add, delete or modify name, address and other identification information, and a logo upload utility 437 for uploading an affiliate logo or other branding information to the e-commerce platform.

The affiliate can further access a customer support utility 427 for implementing a variety of customer support functions. In the illustrated implementation, this customer support utility 427 is forms-based such that affiliate sites can obtain a variety of customer support information by way of entering information on appropriate forms. Finally, via the affiliate dashboard 422, the affiliates can access a utility 428 for managing the affiliate's relationship with the affiliate network. In this regard, the affiliate networks may include a variety of levels at which affiliates can participate. By using the utility 428 the affiliates can upgrade or otherwise modify this relationship.

From the home page 421, perspective affiliates can also access information relevant to making a determination to join the affiliate network. Such information includes testimonials 444, examples and demos 445 showing how the affiliate network functions, and a product tier grid 446 showing the products that are available via the social network for business-to-business platform network and the vertical structure of the product space.

If a prospective affiliate then elects to join the social network for business-to-business platform network, the affiliate can access the create login utility 442. From this login utility 444, the affiliate can access a sign-up form by which the affiliate enters registration information including, for example, name, contact and account information. The affiliate can then access a services selection form 439 by which the affiliate can elect from a number of options as to how the affiliate will participate in the network. In this regard, the affiliate may identify content to be pushed to an affiliate platform, identify an appropriate tier within the market space for placement of the affiliate, select functionality such as dynamic web site building, etc. It should be noted that these various affiliate options are themselves fully customizable in terms of the offering and the pricing by the e-commerce platform managed by the CHI engine and included as part of the social network for business-to-business platform. In cases where a subscription fee is required from affiliates, the affiliate can then access a payment form 438. After payment has been completed, the affiliate will be directed to a receipt page 440, which provides receipt information as well as providing a web master pass phrase, affiliate number and other information.

With this web master pass phrase, affiliates can access a web master utility 447. This utility generally will require a login procedure where the affiliate can enter the web master pass phrase to gain access to web master content. The affiliate can then access an article index generator 448, which provides a variety of web master information.

FIG. 4D illustrates a consumer site that may be accessed in connection with the e-commerce platform via the social network for business-to-business platform. The illustrated site includes a home page 451. From the home page 451, the consumer can access a variety of different utilities. In this regard, the home page 451 may include a link banner 452 with links to a variety of affiliates or vendors of the network. By activating one of these links, the consumer will land at the referred merchant or affiliate 453. Alternatively, from the home page 451 the consumer may elect to shop for products within the specialized product space of the affiliate network. In this regard, the consumer may click on a featured product to access product detail 454. Alternatively, the consumer may initiate shopping by viewing product categories 455. The user may then navigate through a variety of product screens to identify a product of interest. The consumer can then click on the product to view product detail 454. If the consumer elects the product being viewed, that product will be added to the consumer's cart 456. As shown in FIG. 4D, a consumer may also add a featured product or product from the product category view directly to the cart without viewing the product detail. A cart management utility 457 is also provided that allows a consumer to delete items from the cart, change the quantity of any item and see products categorized by vendor.

From the home page 451 the consumer can also obtain information about a newsletter, for example, including information of interest to consumers such as product offerings, events, educational materials and the like. In this regard, the user may access a newsletter detail page 458 to obtain detailed information about the newsletter as well as sign up fields for the newsletter. For example, these fields may allow the consumer to enter an e-mail address or other identification information together with location information for the subscriber, such as zip code information. The user can then access a confirmation page 459 that confirms the newsletter sign-up information and automatically redirects the consumer back to the home page 451.

In the illustrated implementation, from the home page 451 the user can also access an affiliate search utility 463. It should be noted that in any particular vertical market the search and results may specifically relate to affiliates in that vertical market participating in the social network for business-to-business platform. This utility 463 assists consumers in identifying local yoga studios, as an example vertical market affiliate. The search results may identify studios based on location. In addition, studios may subscribe to different tiers within the network. In this regard, there may be, for example, three subscription levels. Thus, a tier 3 studio may be prioritized or placed at the top of the relevant studio listings. Tier 2 studios may be placed in the middle of the listings, and tier 1 studios may be placed at the bottom. Optionally, non-affiliated studios may be identified though generally with a lower ranking in the search results. An advance search utility 462 may be provided that enables a search for studios based on additional criteria such as type of studio, location, class type, name search or the like. The illustrated home page 451 further includes links to advertisers, vendors and studios.

FIG. 4E illustrates an affiliate that may be provided in connection with the e-commerce platform participating in the social network for business-to-business platform. The illustrated administration site 470 includes an entry page 471. For example, login and security information may be entered on the entry page 471 to obtain secure access to administrative functions. From the entry page 471, an authorized operator may access an affiliate (in this implementation “studio”) database 472. The database includes information concerning affiliates such as name, address, account numbers, studio types, location, tier level, etc. Utilities are provided in connection with this database for adding studios 473 and for editing or deleting studios 474. From the entry page 471, an authorized operator can also access a store management utility 475. The store management utility 475 includes category management information 476 and product management information 477. The category management information 476 allows the operator to add, modify or delete the categories associated with stores and products. The product management information 477 includes information identifying the products that are available for sale at the e-commerce platform, availability and back-order information and the like, as well as making that information available to other e-commerce platforms participating in the social network for business-to-business platform.

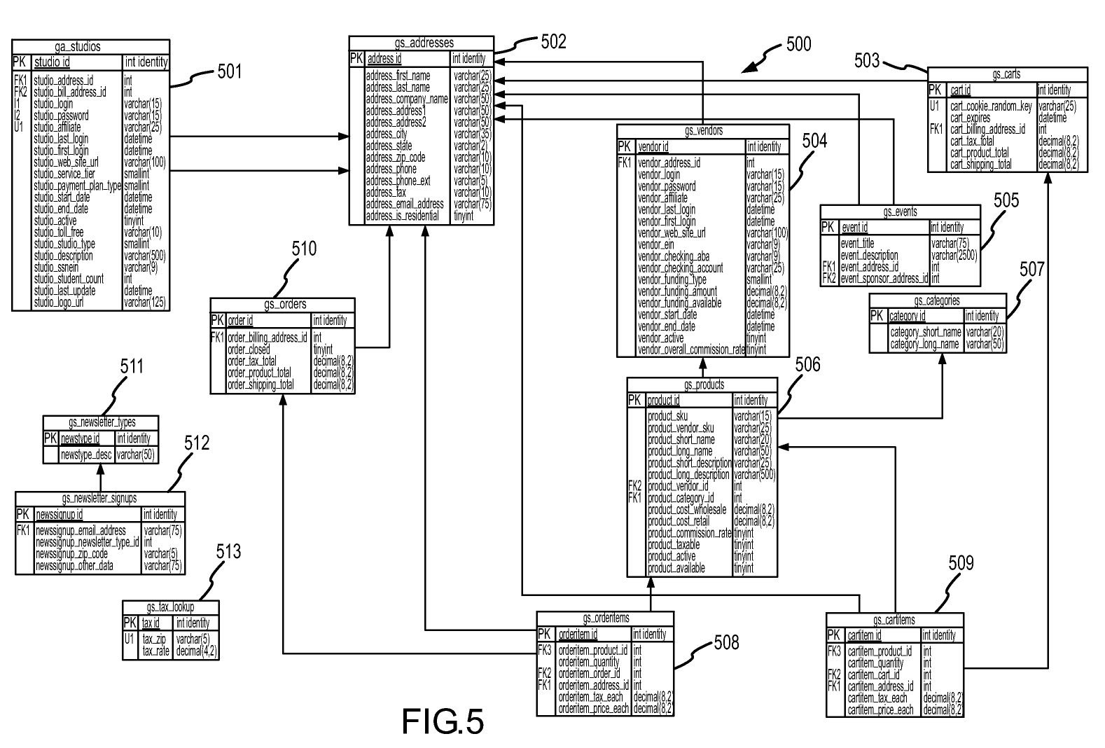

FIG. 5 schematically illustrates a database system 500 associated with the social network for business-to-business platform. A studio table 501 includes information identifying affiliate studios as well as contact information, password information, service tier information and a variety of other information regarding individual studios. An address table 502 includes addresses and associated contact information for various participating entities of the affiliate network. A cart table 503 logs information for individual shopping carts used by consumers visiting the e-commerce platform participating in the social network for business-to-business platform. The vendor table 504 includes identification, account and other information for vendors of the affiliate network. The events table 505 includes a number of fields identifying information regarding events that can be accessed via the e-commerce platform. The products table 506 include product information, such as SKUs, vendor identification categories, cost information, tax information and the like. The categories table 507 includes information identifying the categories of products available at the e-commerce site. Order items table 508 logs information regarding items ordered by a consumer. The cart items table 509 logs information regarding items added to a cart by a visiting consumer. The order tables 510 include information regarding an order, including, for example, a billing address, a product total, a shipping total and the like. The newsletter types table 511 identifies the types of newsletters that are available via the e-commerce site. The newsletter sign-up table 512 collects information regarding newsletter type, e-mail addresses, zip codes and other information related to newsletter delivery. Finally, the tax lookup table 513 logs information useful in determining an applicable tax related to an order. The connections between the various fields are indicated by arrows in FIG. 5. Thus, it will be appreciated that fields from certain tables are used to populate fields of related or overlapping databases configured for the social network for business-to-business platform.

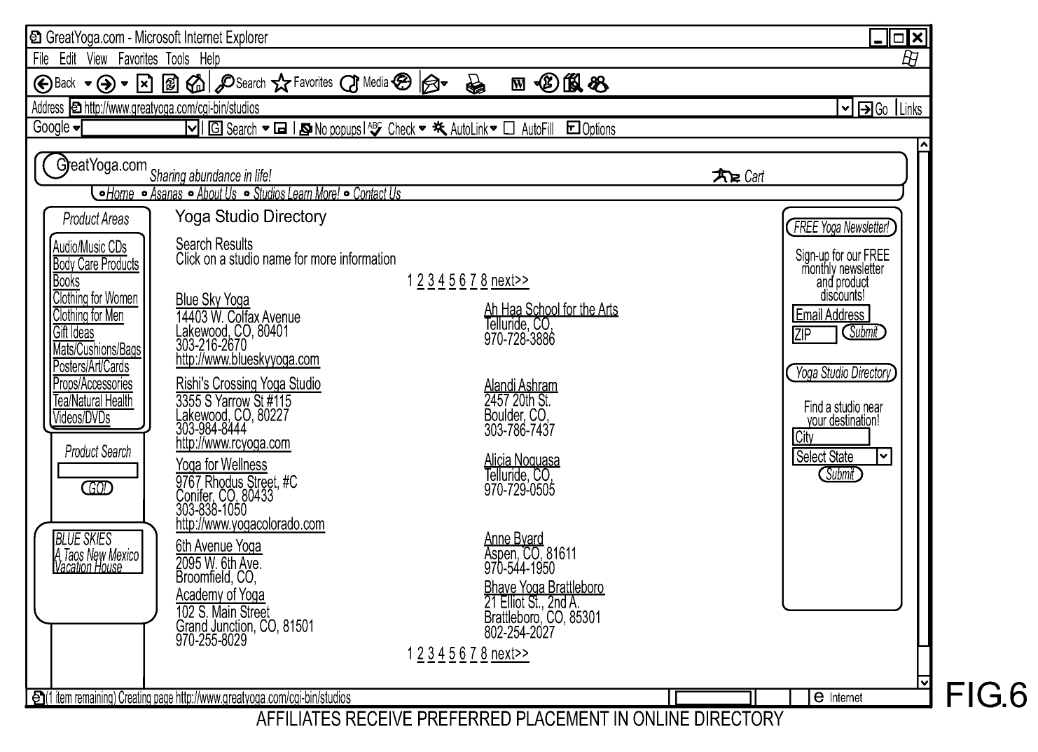

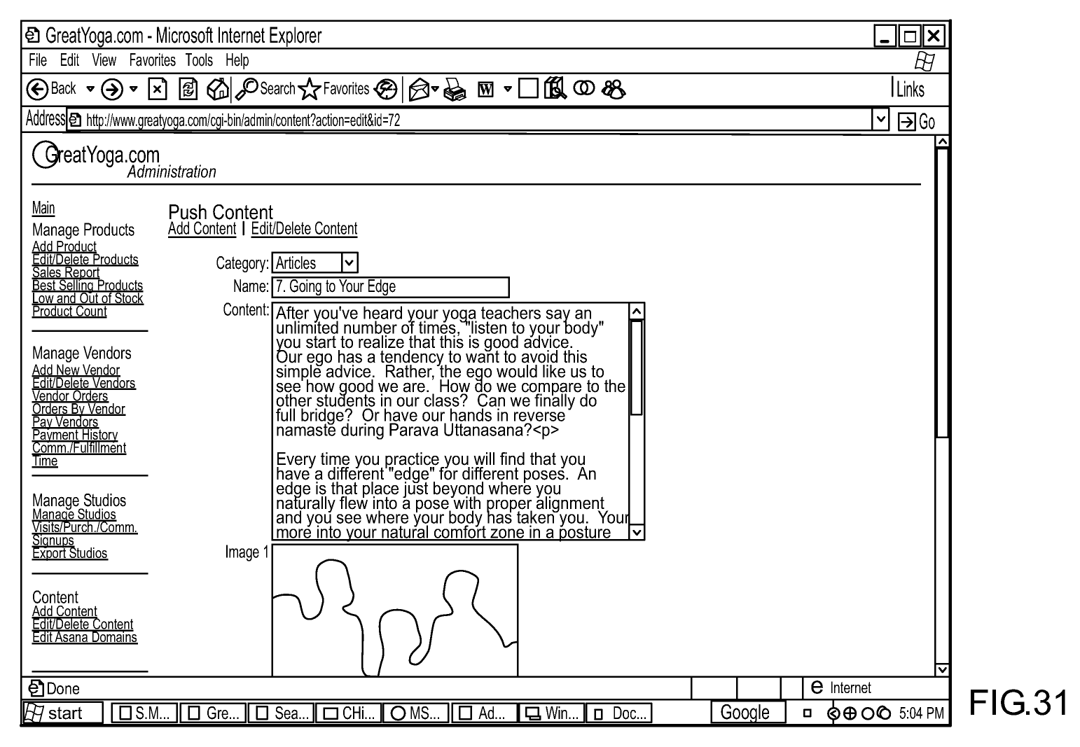

The structure and functionality of the social network for business-to-business platform and the affiliate network can be further understood by reference to the screen shots of FIGS. 6-34. FIG. 6 is a screen shot illustrating search results in an online directory. It is anticipated that the e-commerce platform being generated by the CHI Engine in this particular implementation will become a popular resource for persons interested in various vertical market industries. As discussed above, affiliates, in one implementation, may be required to pay a fee in connection with joining the affiliate network. Moreover, there may be an option for affiliates to join at different tier levels. An advantage of becoming an affiliate is that affiliates will receive preferred placement in an online directory, as illustrated in FIG. 6.

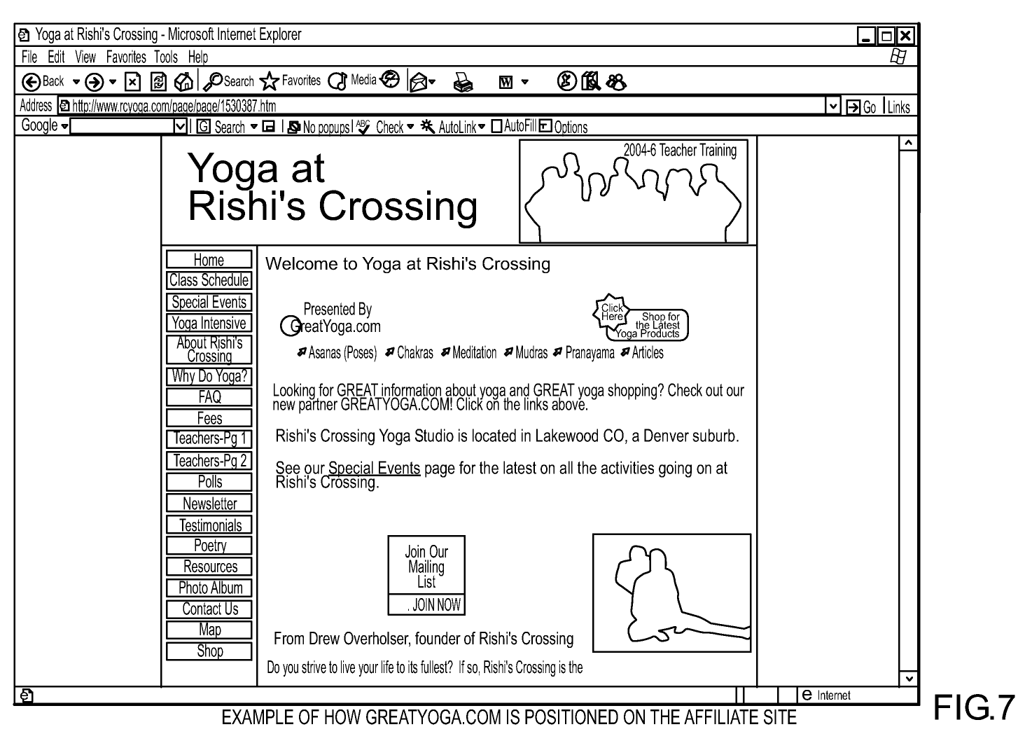

As discussed above, an affiliate network brand name may be displayed in connection with affiliate sites. FIG. 7 illustrates how this branding information may appear in one example. In this case, the affiliate site includes the identification “presented by GreatYoga.com.”

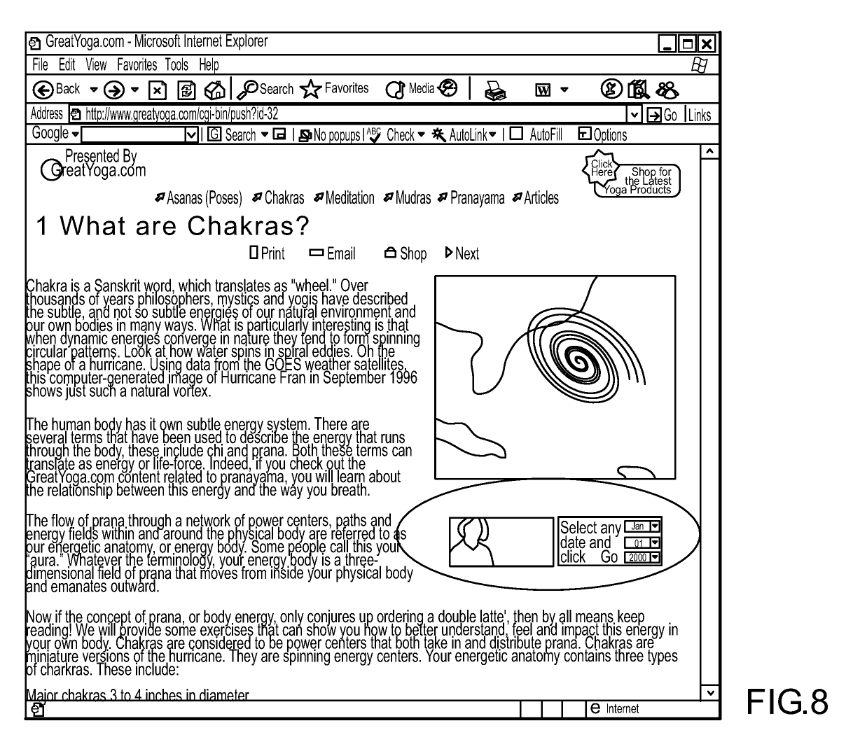

The affiliate network also provides a powerful mechanism for advertising. In particular, it is possible to accurately target commercial impressions, as the e-commerce site will gather consumers having an interest in a common market. Moreover, it is possible to target advertising based on location. As noted above, subscribers to newsletters may enter a zip code or other location information that allows consumers to be located. Moreover, location information may be collected in connection with offers, at least for consenting consumers. Advertisers can then use the social network for business-to-business platform to send e-mails for activities such as workshops, conference or studio specials to consumers within a specific radius of a defined location. This is an extremely valuable service for direct and timely marketing for vendors, affiliates and other advertisers. Advertising campaigns not only appear on the e-commerce platform but also appear on any private label content that is served to an affiliate site as well as all participating e-commerce platforms within the social network for business-to-business platform. An example of this is shown in FIG. 8.

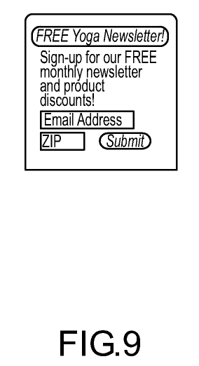

As discussed above, subscribers to a newsletter may be prompted to enter identification information, as well as location information, when subscribing to receive a newsletter. For example, the location information may be obtained by way of a zip code entered as part of the newsletter's registration process. An associated registration graphical user interface is illustrated in FIG. 9.

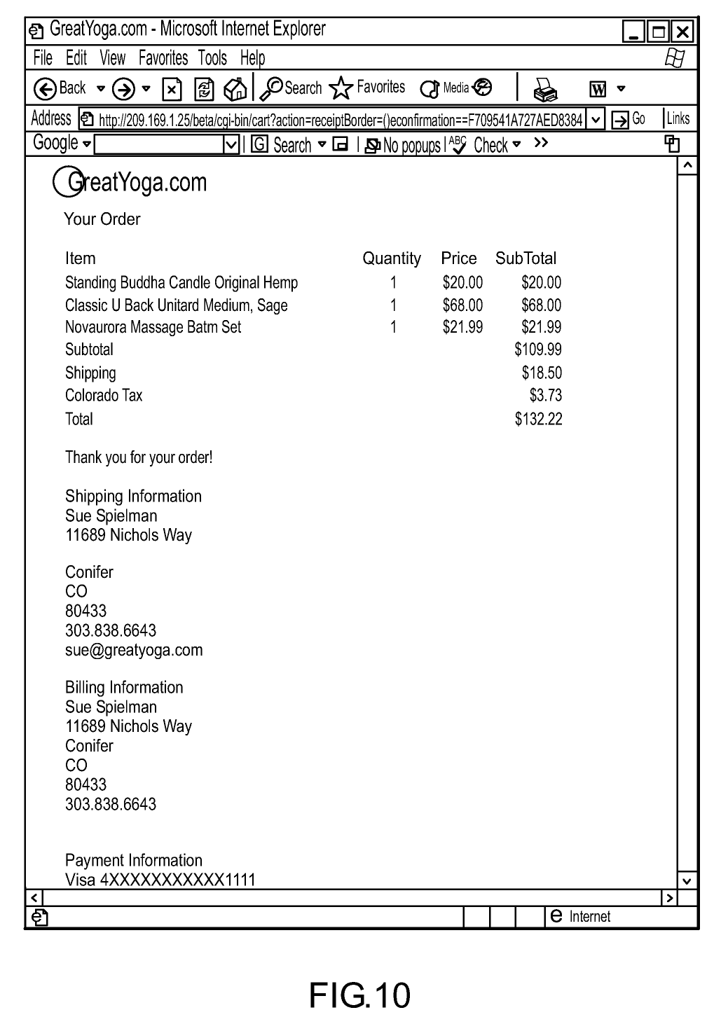

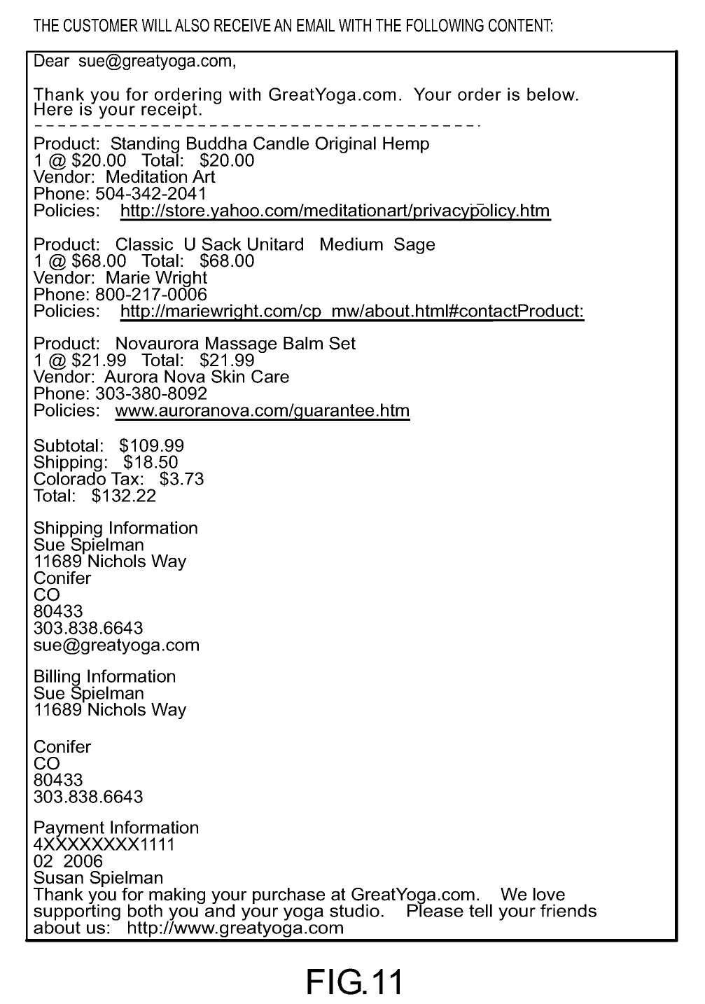

FIGS. 10 and 11 show order confirmation information that is provided to consumers upon placing an order via the social network for business-to-business platform. Specifically, FIG. 10 shows an order confirmation printable page, and FIG. 11 shows an e-mail that is delivered to the consumer.

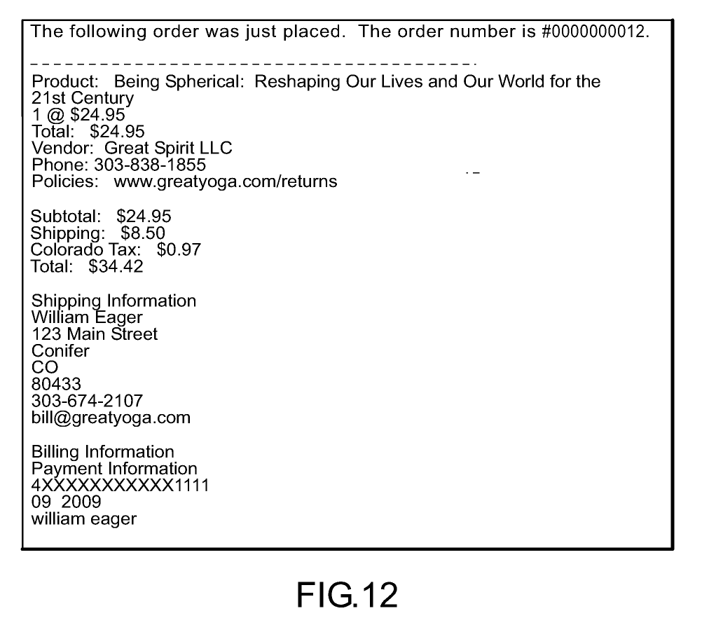

FIG. 12 shows a vendor notification that is delivered to a vendor in connection with an order. As noted above, a single order may include multiple products from multiple vendors. Accordingly, multiple notifications may be provided to multiple vendors in connection with an order. FIG. 12 illustrates an e-mail notification that may be sent to a vendor in this regard. This e-mail may be used by the vendor for its records and for fulfillment purposes. The automatically generated vendor e-mail also includes a direct link to the vendor site where the vendor can notify the social network for business-to-business platform when an order has been fulfilled or backordered.

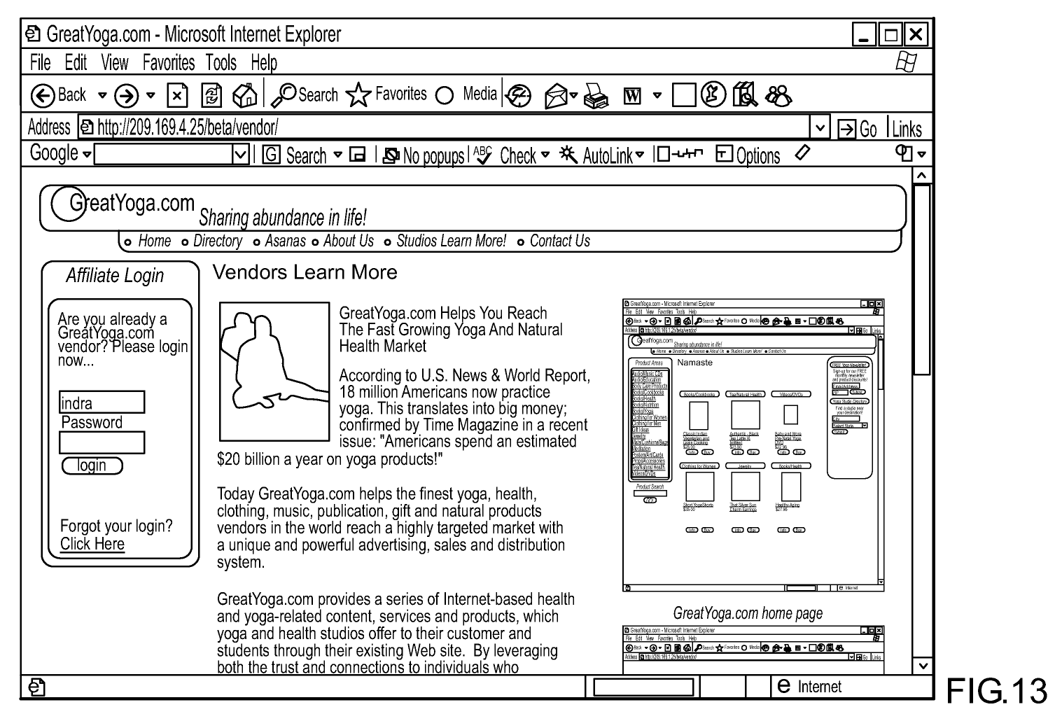

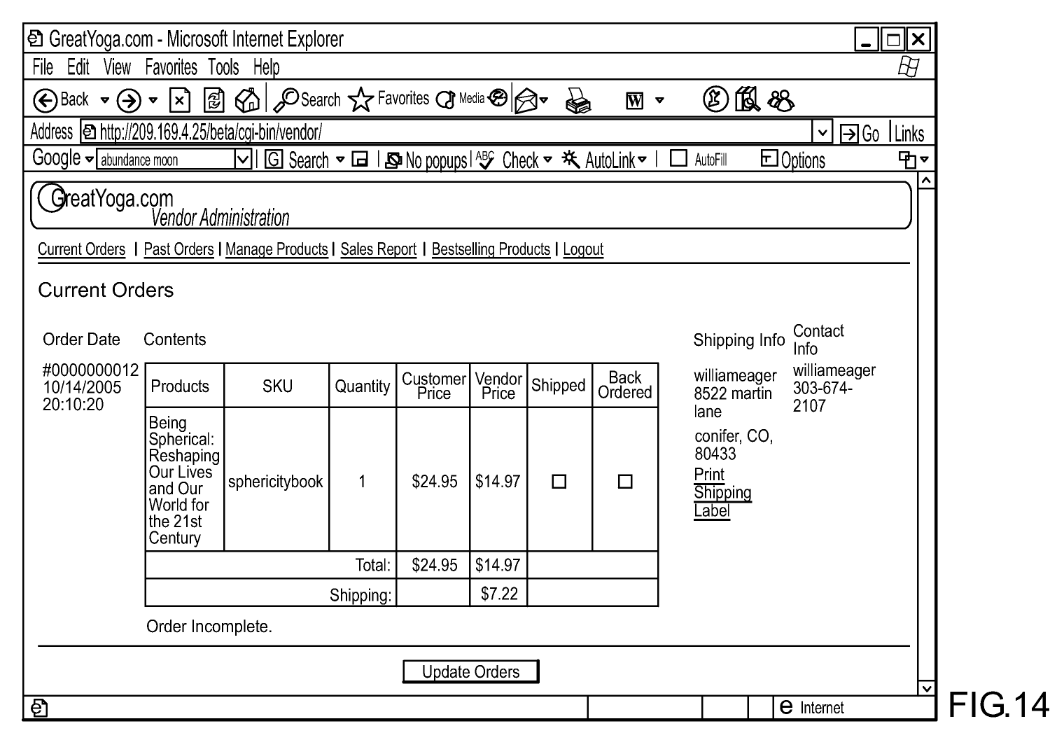

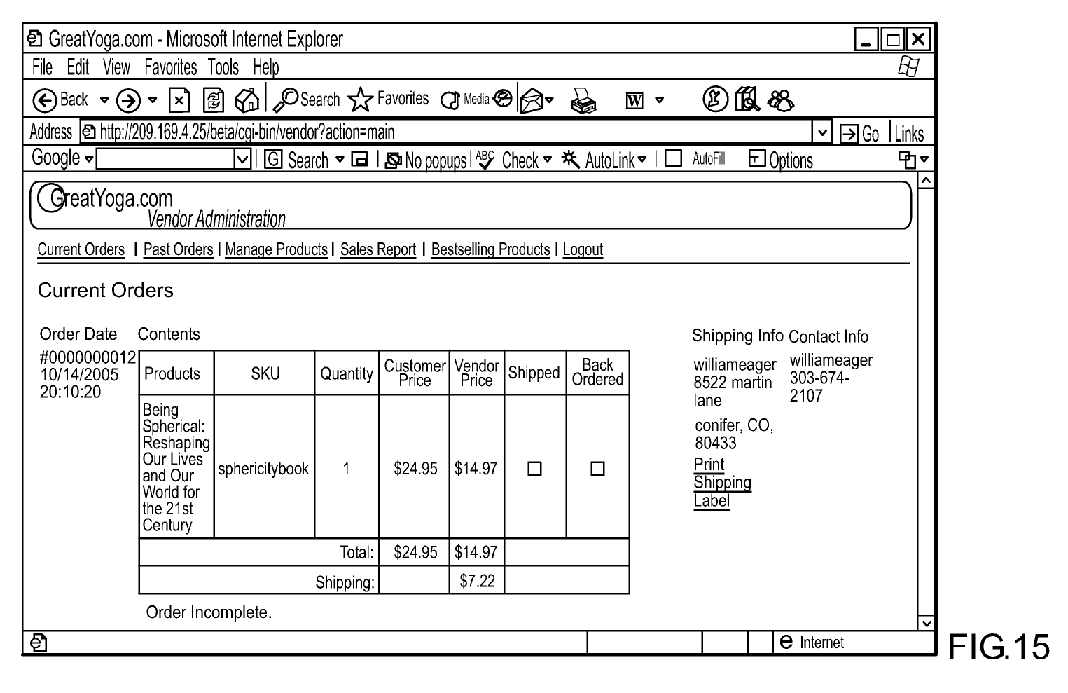

FIG. 13 illustrates a user interface that may be provided in connection with the vendor dashboard. In particular, the illustrated web page includes a login interface for vendors to login to the vendor dashboard system. Once the vendor has entered the vendor dashboard, the vendor can access a current order screen, as shown in FIG. 14. This screen shows orders that remain unfulfilled. As shown in FIG. 15, the vendor can check either the shipped box or the back-ordered box on the current order screen to update order information. The CHI engine automates a process wherein if the vendor indicates an order is fulfilled the social network for business-to-business platform and administration site are so notified. At such time that all vendors on a specific consumer order (i.e., one consumer order may represent products and services from multiple vendors) indicate either fulfillment or backorder; the consumer's credit card is charged. This functionality ensures that the consumer's credit card is never charged until there is confirmation of fulfillment or backorder; thereby providing a significant level of consumer protection. Further, if a vendor indicates backorder (i.e. product or service not currently available for fulfillment) the CHI engine automatically takes this product and service off the order so that the order may be processed and automatically notifies the consumer of the backorder status and that they are not being charged for said product or service. Once an order is complete and payment has been obtained from the consumer, for example, by charging the consumer's credit card, payments may be made to vendors. For example, this may be accomplished by way of fully automated electronic payment. The administration site provides for complete reporting on vendor payments to be make, history of vendor payments made with date stamp; method of payment, etc.

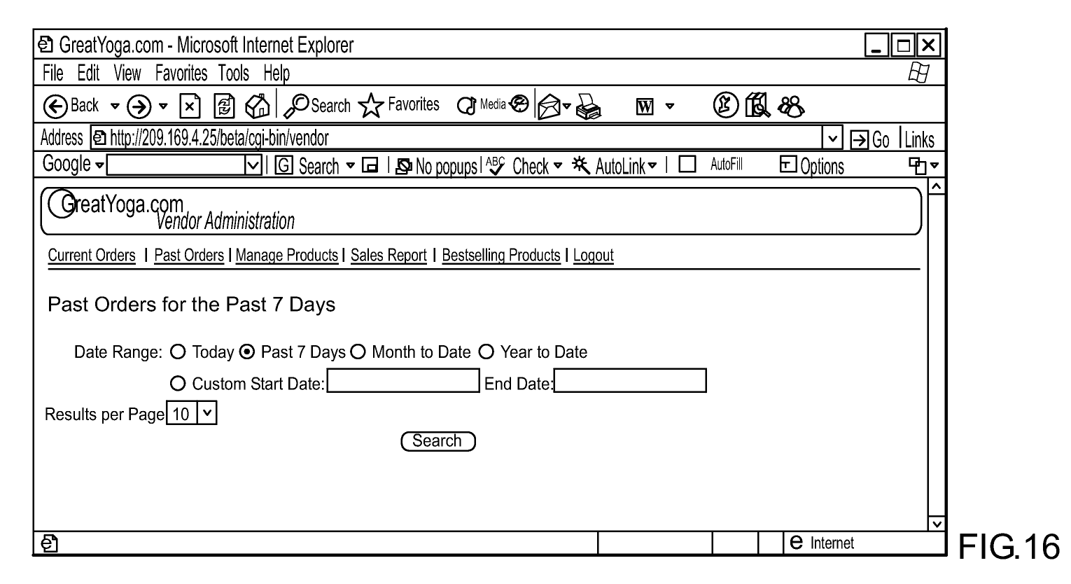

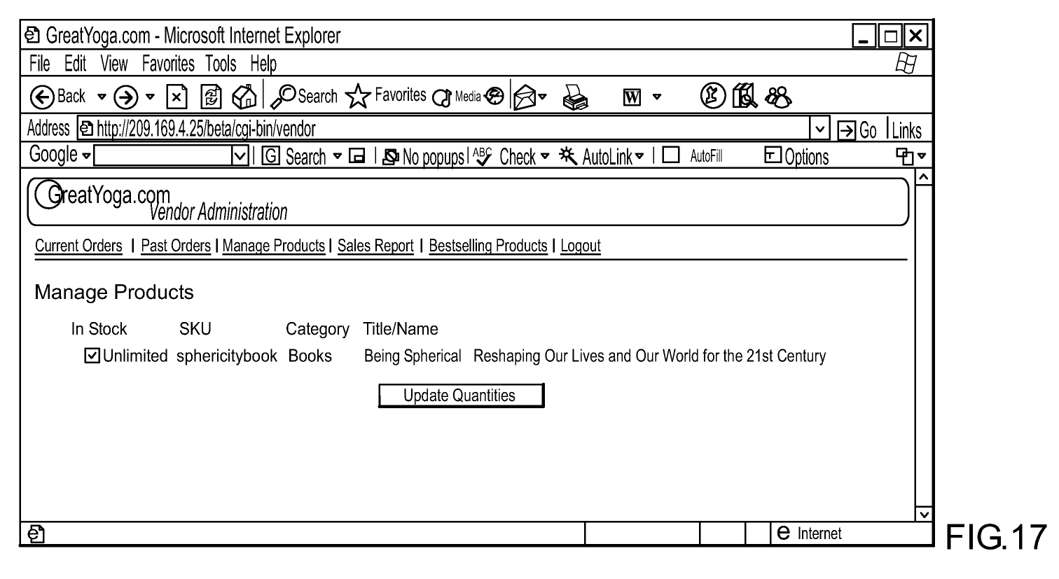

The vendor can also use the vendor dashboard to check past orders. In this regard, the screen of FIG. 16 allows the vendor to check orders from today, for the past seven days, for the month to date and for the year to date or to create a custom field. The vendor dashboard also allows vendors to manage their products. In this regard, the vendor can search for a specific product by SKU, name or category or all products can be displayed. FIG. 17 shows a product listing. It is noted that the “in stock” column in FIG. 17 has a check box. If the vendor has a significant quantity of the product, the vendor can leave it unchecked, and the product will continue to be listed for purchase on the social network for business-to-business platform. If it is a specialty product or a product on which the vendor is running low on inventory, a quantity number can be entered into the text field. At such time that inventory reaches zero, the product or service is automatically removed from availability on the social network for business-to-business platform; visually represented by an “out-of-stock” graphic.

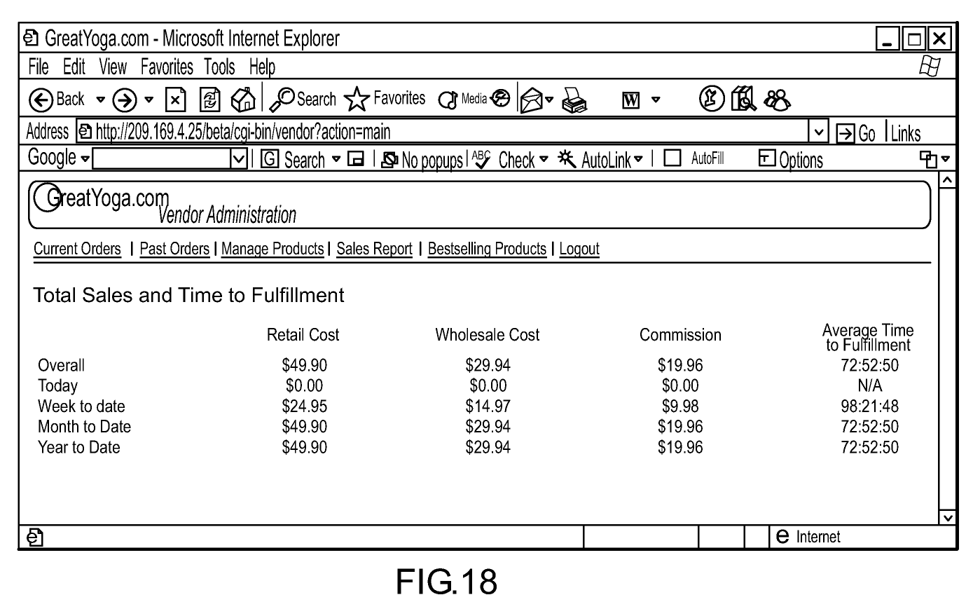

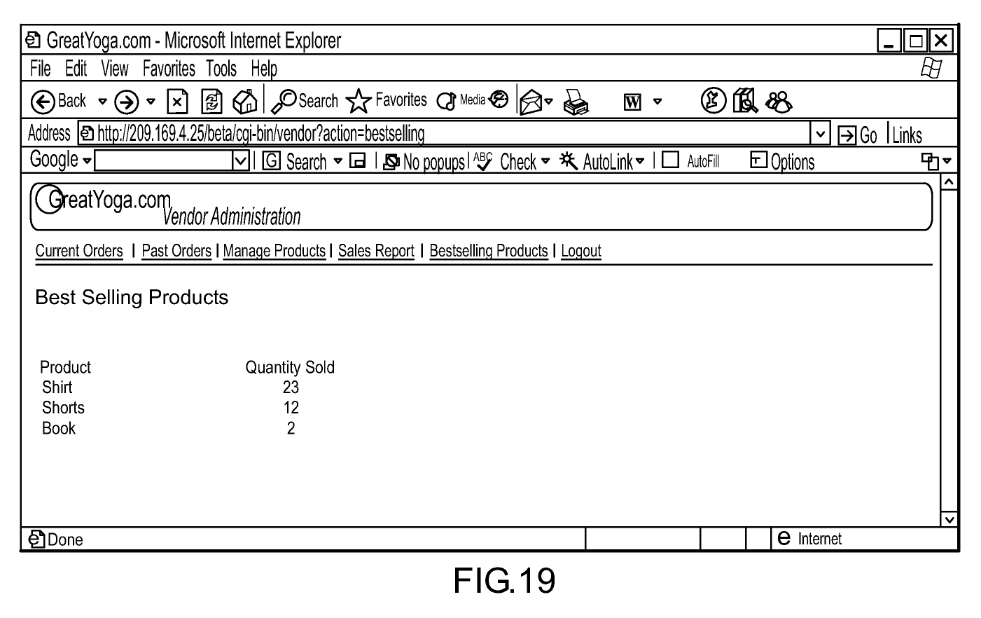

The vendor dashboard can also be used to obtain sales reports. Using these reports, the vendor can view sales for the day, for the week to date, for the month to date, the year to date and can obtain information regarding retail costs, wholesale costs and commissions for the time period, as well as the average time to fulfillment. A sample screen shot in this regard is shown in FIG. 18. If the vendor is interested in what products are selling the best, the vendor can view products listed by clicking on the best selling products link. FIG. 19 shows what a corresponding screen looks like.

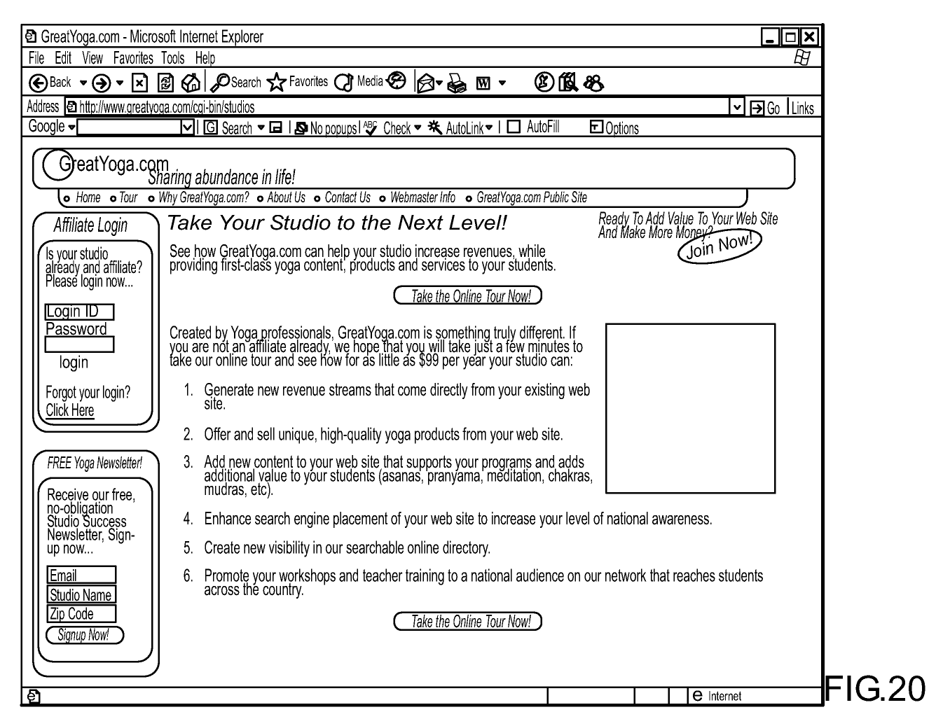

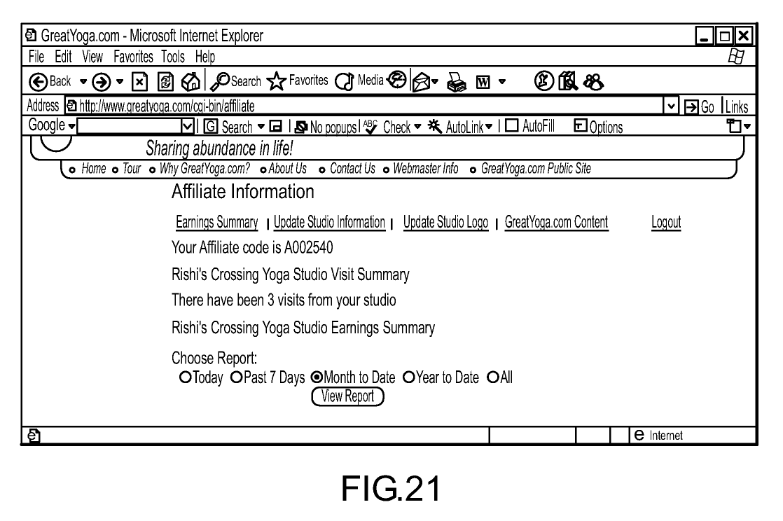

A variety of screens are also provided related to the affiliate site. FIG. 20 illustrates an affiliate logon page, including information as well as login fields and newsletter reminder fields. After logging in, the affiliate proceeds to the affiliate main page, as illustrated in FIG. 21. From the main page, the affiliate is able to track commissions, visits, update studio information and access the code for affiliate's web site.

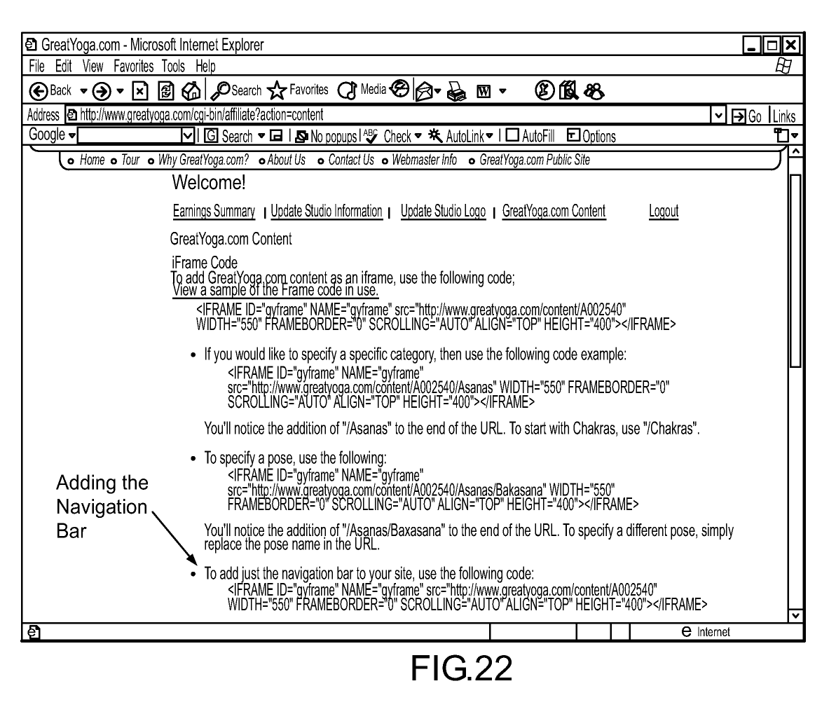

From the main page, if the affiliate clicks on the link “GreatYoga.com content,” the affiliate can view specific pre-generated code to use at the affiliate site. It is noted that the pre-generated code includes the affiliate's ID number. In this regard, there are several code options available to suit the affiliate's specific needs. The affiliate can add content to a specific category (like mediation), a specific Asana or the affiliate can have all of the GreatYoga.com content available on its site. An example of the navigation bar code is shown in FIG. 22.

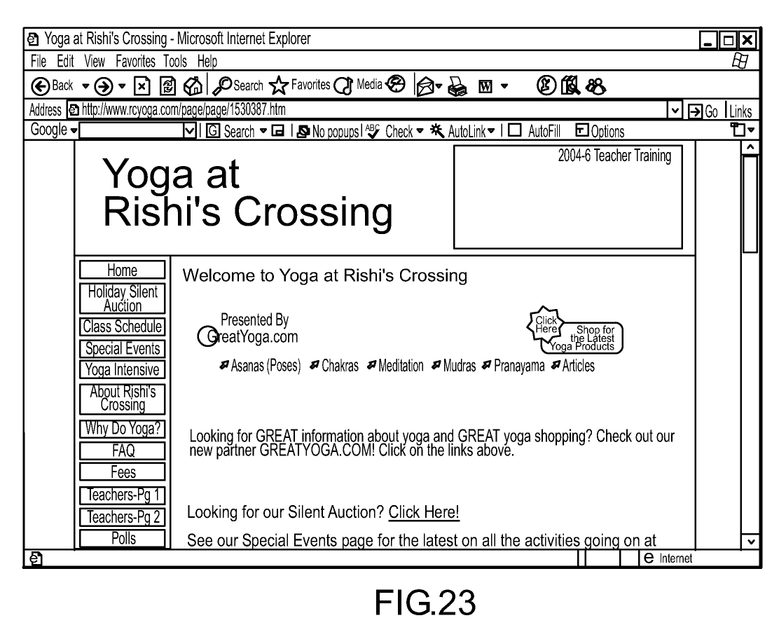

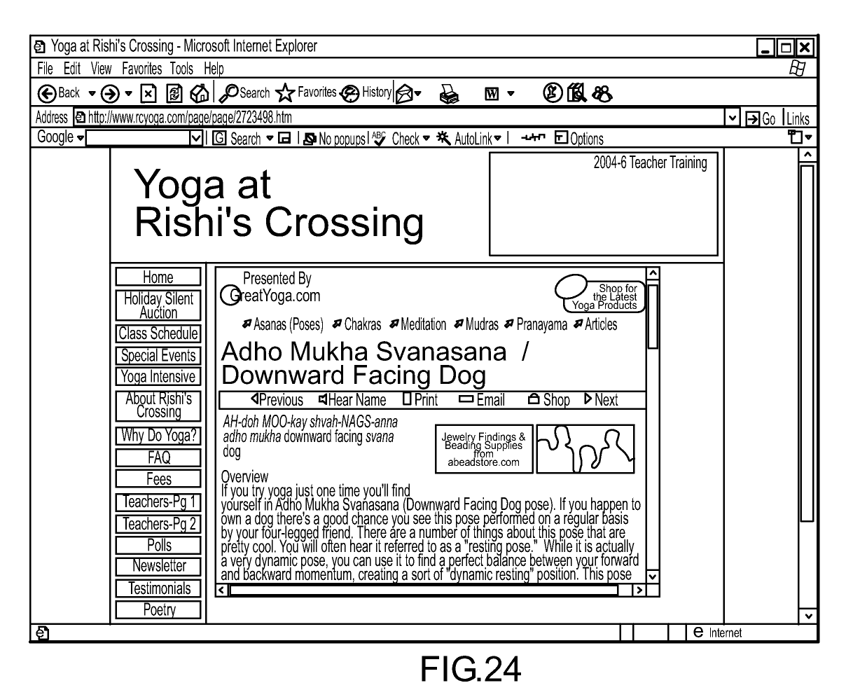

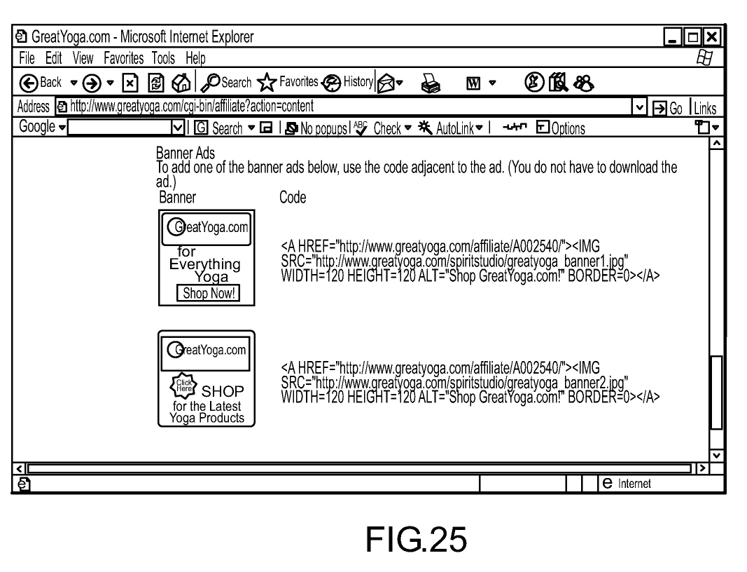

An iFrame code, or another code that might provide this type of functionality, allows the affiliate to create a space on its site to display content pushed from the e-commerce platform. Alternatively, only a menu bar may be pushed from the social network for business-to-business platform to the affiliate site. It is noted that, by using the iFrame options to push content to the affiliate site, the affiliate may receive a higher ranking from search engines. FIG. 23 shows an affiliate site, including the navigation bar. Alternatively, the affiliate site may receive a navigation bar that includes the content, as shown in FIG. 24. Another option is to receive a banner on the affiliate site and not include the affiliate network navigation bar. FIG. 25 illustrates examples of banners for affiliates.

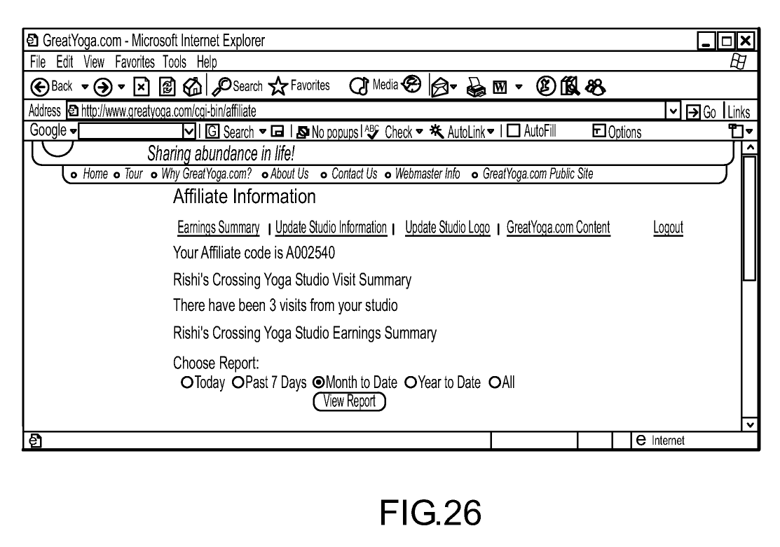

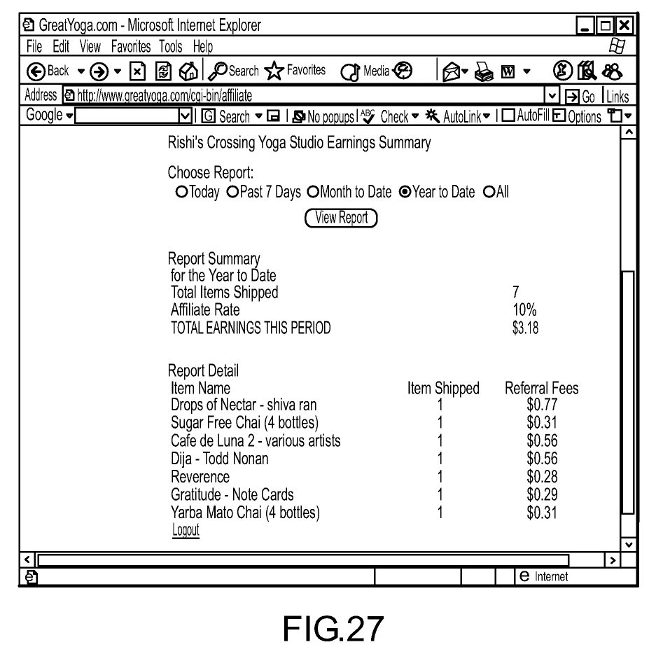

Affiliates can also use the social network for business-to-business platform to access reports. In this regard, FIG. 26 illustrates an affiliate main page. From the main page, to view a report, the affiliate can simply select a time frame for which the report is desired and click the “view report” button. A report will then be provided as illustrated in FIG. 27. This includes a report summary as well as report details that include the number of products purchased through the affiliate site, the total earnings so far for the period and details on the specific products purchased. The affiliate main page (FIG. 26) can also be used to update affiliate (studio) information by clicking on the “update studio information” button.

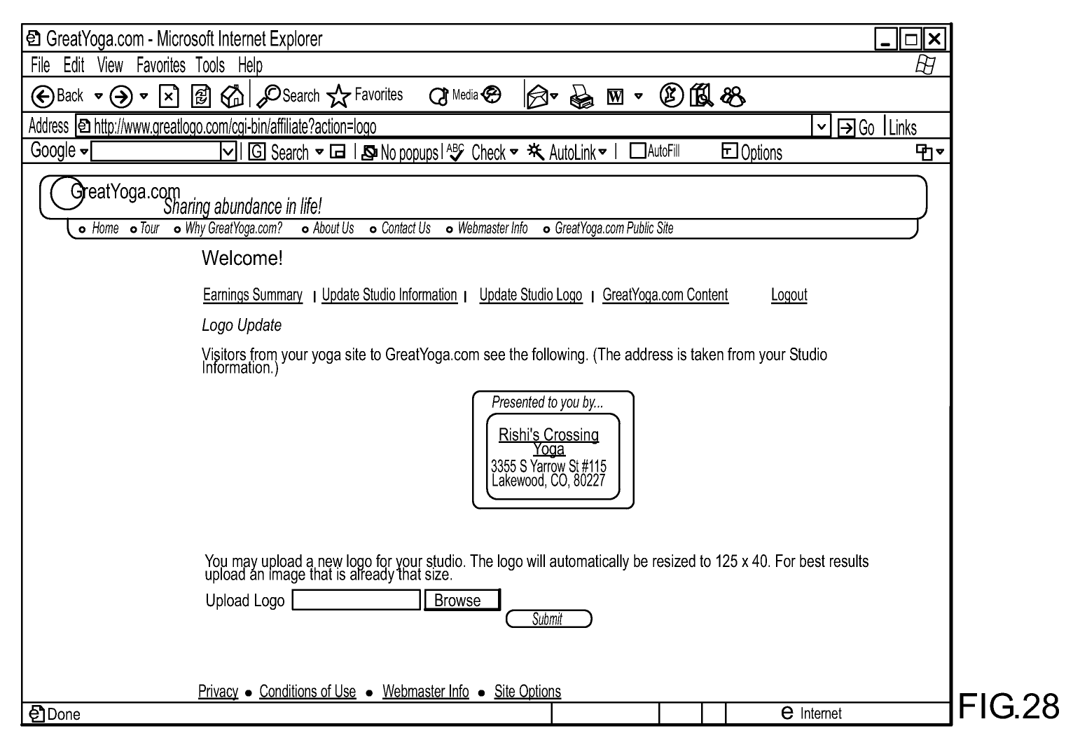

As discussed above, one significant feature of the affiliate network is that the affiliate logo or brand information is maintained throughout the social network for business-to-business platform when consumers are referred to the social network for business-to-business platform from the affiliate platform. Thus, for example, if a yoga student clicks through from an affiliate (studio) site to purchase something or view content at the e-commerce platform (GreatYoga.com web site) is participating in the social network for business-to-business platform, the affiliate's (studio's) site logo, or the studio name and address, will appear on the e-commerce platform (GreatYoga.com) home page. The affiliate can preview how this will appear or upload a logo or other branding information by clicking on the “updated studio logo” button on the affiliate main page. FIG. 28 shows a sample page in this regard. Commissions may be paid to affiliates electronically on a periodic basis, e.g., quarterly. Finally, to log out from the affiliate site, the affiliate can click the “log out” button on the affiliate main page.

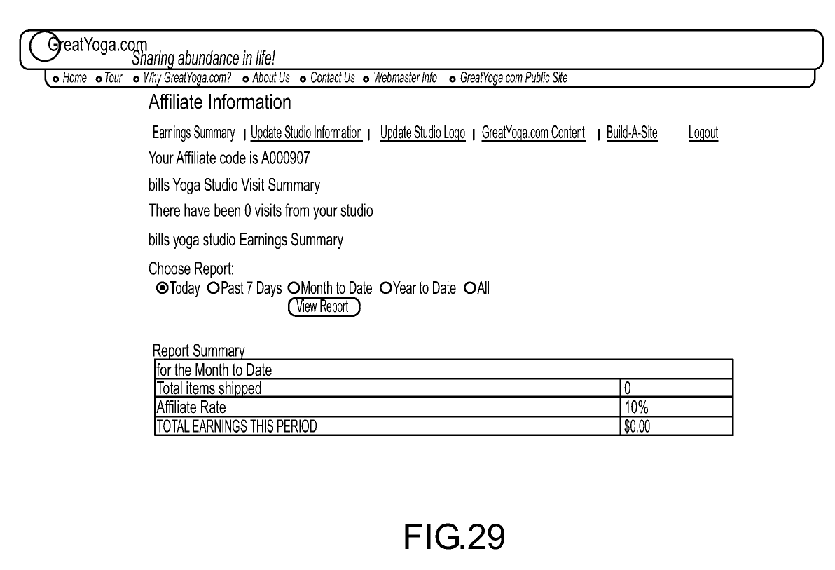

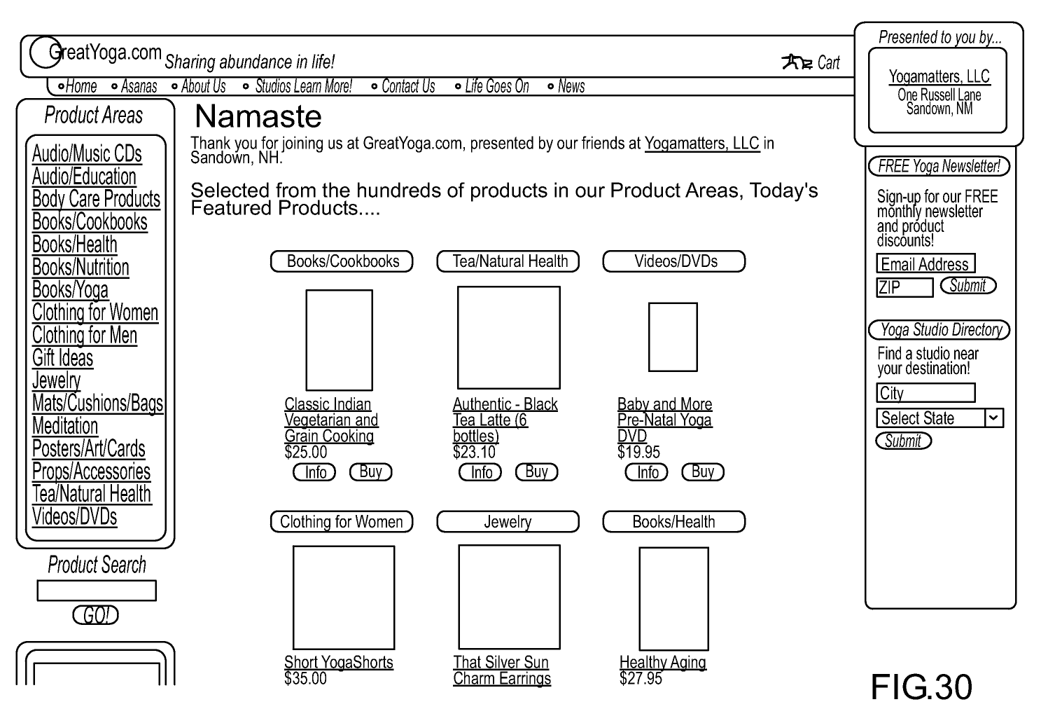

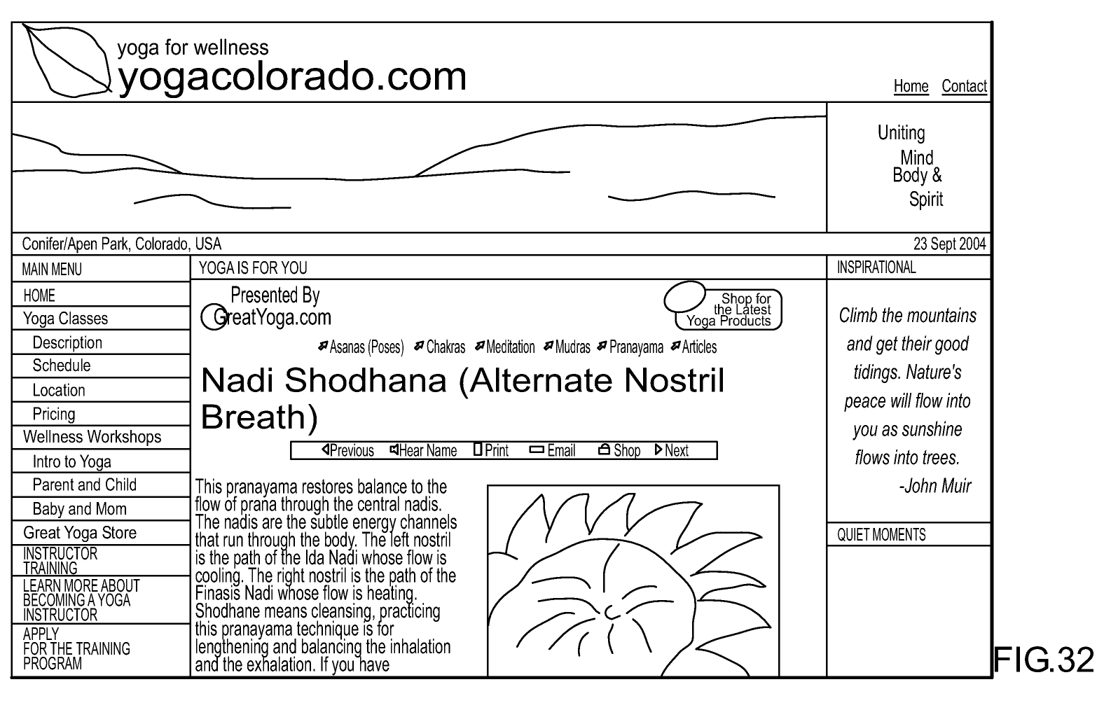

The CHI engine enables any market space to create an online affiliate network, which pushes both traffic and sales through the e-commerce platform participating in the social network for business-to-business platform. The CHI engine also provides the processes to allow an affiliate to register to become an affiliate of any desired affiliate network. When an affiliate registers, they receive a unique code they place on their web site that identifies them and enables the CHI engine to push content directly to their existing site. In addition, the affiliate can access the secure affiliate administration system as discussed above. FIG. 29 illustrates an affiliate administration site. FIG. 30 provides another example illustrating use of the affiliate brand in connection with the e-commerce platform. FIG. 38 illustrates an administration site for selecting push content to be pushed to an affiliate site. FIG. 32 shows push content as displayed at the affiliate site.

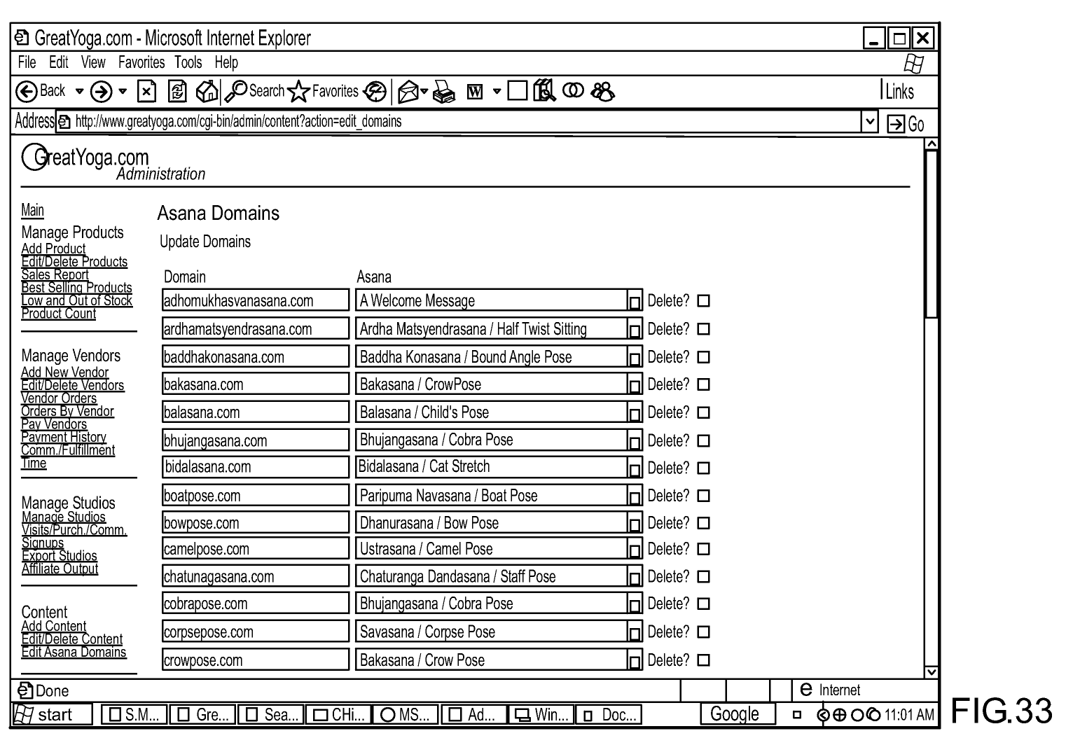

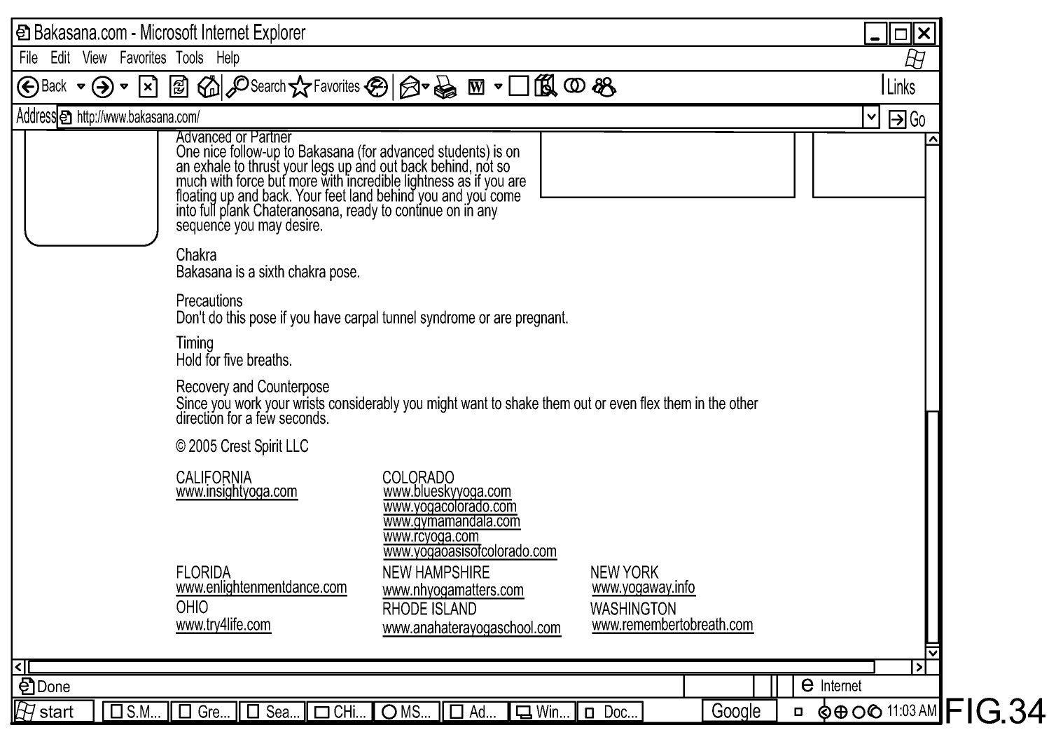

As discussed above, affiliates may be automatically linked to multiple URLs. That is, the CHI engine permits the social network for business-to-business platform manager, via the Administration Site, to add a number of discrete web page domain names or URLs into a database. These domain names need to be registered and owned by the e-commerce platform manager, owner or licensee. The e-commerce platform manager, owner or licensee can then create content, which is pushed to these domains, and when an affiliate joins the market space created by the CHI engine, their web site domain address is automatically listed and linked on each of these domains. This serves multiple purposes. First, it helps provide an additional level of visibility to the affiliate. Any time a visitor goes to any of the other domains, they can find and jump directly to the affiliate's site. Moreover, many internet users open their browsers and directly type in web addresses they feel will provide useful results. The CHI engine enables affiliates to effectively use any number of domain names they register so as to drive traffic both to the affiliate network but also to the affiliate. Moreover, search engines may use a system that calculates the number of domain names or sites that link to a site to determine their placement in the results pages. So, the noted system may help affiliates get a better ranking in the search engines. FIG. 33 illustrates a process for adding an managing multiple domains. Finally, FIG. 34 illustrates how the CHI engine connects and manages domain pages with content in affiliate links.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. A network for business-to-business method, comprising the steps of:
identifying a tiered vertical market defined by a market space, said potential tiered vertical market including vendors of products or services within said market space, consumers of said products or services, and potential affiliates having a business interest complementary to an industry of said market space;
establishing an e-commerce platform that can be linked to affiliate platforms of said potential affiliates for electronic transfer of information between said e-commerce platform and said affiliate platforms, and that can be linked to vendor platforms of said potential vendors for electronic transfer of information between said e-commerce platform and said vendor platforms;
establishing links between said first e-commerce platform and a first number of said affiliate platforms and between said e-commerce platform and a second number of said vendor platforms;
receiving, at said e-commerce platforms, an order including order information from one of said consumers directed to said e-commerce platform via a referring affiliate platform of said linked affiliate platforms, said order information identifying for purchase one or more of said products or services from one or more of said linked vendors; and
operating said e-commerce platform to communicate with said referring affiliate platform and/or one or more of said linked vendors in relation to fulfillment of said order.

2. A method of claim 1, further comprising the step of establishing a social network of a plurality of e-commerce platforms associated with a plurality of tiered vertical markets to communicate between each other as part of a unified social networking system.

3. A method as set forth in claim 2, wherein one of a vendor and a product of a first tiered vertical market can be added to a second tiered vertical market via said social network.

4. A method as set forth in claim 2, wherein an advertiser of a first tiered vertical market can be added to a second tiered vertical market via said social network.

5. A method as set forth in claim 2, further comprising the step of using the social network to provide online e-marketing to at least some customers of each of a first tiered vertical market and a second tiered vertical market.

6. A method as set forth in claim 1, wherein said potential affiliates comprise one of local retailers, service providers and agents related to said industry.

7. A method as set forth in claim 1, further comprising the step of using said links between said e-commerce platform and said affiliate platforms to provide content from said e-commerce platform to at least one of said affiliate platforms.

8. A method as set forth in claim 7, wherein said content comprises one of articles, educational materials, and informational materials related to said industry.

9. A method as set forth in claim 7, wherein said content comprises one of text, images, links, audio and multimedia content.

10. A method as set forth in claim 1, further comprising the step of using said links between said e-commerce platform and said affiliate platforms to provide branding information from at least a first affiliate of said platform affiliate platforms at said e-commerce platform.

11. A method as set forth in claim 1, further comprising the step of identifying, in connection with a visit by a consumer to said e-commerce platform, a referring affiliate associate with said visit, and providing, in connection with said visit, branding information of said referring affiliate on a user interface of said e-commerce site.

12. A method as set forth in claim 1, wherein said step of receiving comprises receiving multiple vendor product order information identifying products of a plurality of vendors.

13. A method as set forth in claim 12, further comprising the step of providing, via said e-commerce platform, in connection with said multiple vendor product order information, a single check-out process for purchasing said identified products of said multiple vendors.

14. A method as set forth in claim 1, wherein said step of operating comprises transmitting order information to said one or more linked vendors in connection with said order.

15. A method as set forth in claim 1, wherein said step of ordering comprises reporting account information to said referring affiliate regarding remuneration to said referring affiliate associated with said order.

16. A method as set forth in claim 15, wherein said reporting comprises providing aggregated account information related to multiple orders on a periodic basis.

17. A method as set forth in claim 1, further comprising the step of operating said platform to access product availability information in connection with said order.

18. A method as set forth in claim 1, further comprising the step of operating said e-commerce platform to provide order status information to one or more consumers.

19. A method as set forth in claim 1, further comprising the step of obtaining consumer identification information and consumer location information regarding consumers visiting said e-commerce platform.

20. A method as set forth in claim 19, wherein said step of obtaining comprises prompting said consumers to enter said information.

21. A method as set forth in claim 19, wherein said step of obtaining comprises storing a zip code associated with one of said consumers.

22. A method as set forth in claim 19, wherein said step of obtaining is implemented in connection with a registration process wherein said consumer registers to receive transmitted information from said e-commerce platform.

23. A method as set forth in claim 22, wherein said transmitted information comprises a newsletter concerning said industry.

24. A method as set forth in claim 22, wherein said transmitted information comprises consumer generated information.

25. A method as set forth in claim 8, wherein said content includes branding information of said affiliate platform.

26. A method as set forth in claim 19, further comprising the step of using said consumer location information to provide location specific information to consumers.

27. A method as set forth in claim 25, wherein said location specific information relates to affiliates in a vicinity of a location of a consumer.

28. A method as set forth in claim 1, further comprising the step of linking multiple internet addresses associated with a single affiliate to said e-commerce site.

29. A method as set forth in claim 27, further comprising the step of providing affiliate branded content from said e-commerce site to each of said multiple internet addresses.

30. A social network for business-to-business method, comprising the steps of:
First operating an affiliate platform to access an e-commerce platform for linking vendors of products within a product space, consumers of said products, and affiliates having a business interest complementary to an industry of said products;
second operating said affiliate platform to establish a link between said e-commerce platform and an affiliate platform; and
third operating said affiliate platform to communicate with said e-commerce platform.

31. A method as set forth in claim 30, wherein said step of third operating comprising transmitting branding information from said affiliate platform to said e-commerce platform.

32. A method as set forth in claim 30, wherein said step of third operating comprises receiving information from said e-commerce platform and presenting said information at said affiliate platform together with affiliate branding info.

33. A method as set forth in claim 30, wherein said step of third operating comprises operating said affiliate platform to access account information regarding remuneration to an affiliate associated with referring consumers to said e-commerce platform.

34. A method as set forth in claim 30, wherein said step of operating comprises linking said affiliate site with multiple domain names via said e-commerce platform.

35. A method as set forth in claim 30, wherein said step of operating comprises operating said affiliate platform to access an administration system of said e-commerce platform to enter or edit affiliate information regarding an affiliate.

36. A method as set forth in claim 35, wherein said affiliate information is directly reflected on a consumer site accessed by consumers.

37. A method as set forth in claim 35, wherein said affiliate information is directly reflected on multiple sites associated with said e-commerce sites, wherein said multiple sites are linked to said affiliate platform.

38. A social network for business-to-business method, comprising the steps of:
accessing an e-commerce platform for linking vendors of products within said product space, consumers of said products and affiliates having a business interest complementary to an industry of said products;
establishing a link between said e-commerce platform and a vendor platform of one of said vendors; and
operating said vendor platform to communicate with said e-commerce platform.

39. A method as set forth in claim 38, wherein said step of operating comprises transmitting product offering information from said vendor platform to said e-commerce platform.

40. A method as set forth in claim 38, wherein said step of operating comprises receiving consumer product order information from said e-commerce platform.

41. A method as set forth in claim 38, wherein said step of operating comprises operating said vendor platform to access an administration system of said e-commerce platform for one of managing orders, managing inventory, managing product or service offerings and obtaining vendor account information.

42. A method as set forth in claim 38, wherein said step of operating comprises operating said vendor platform to input vendor information regarding one of inventory and product or service offerings, wherein said vendor information directly impacts a consumer site accessed by consumers.

43. A method as set forth in claim 38, wherein said step of operating comprises operating said vendor platform to input vendor information regarding order status, wherein said vendor information directly impacts initiation of a customer payment process.

44. A method as set forth in claim 38, wherein said step of operating comprises providing banking information of a vendor to said e-commerce platform.

45. A method as set forth in claim 44, further comprising the step of transferring said banking information to a secondary environment securely separated from an e-commerce consumer site of said e-commerce platform.

46. A method as set forth in claim 45 using said banking information from said secondary environment for processing a payment to said vendor.

47. A social network for business-to-business method, comprising the steps of:
first accessing an e-commerce platform for linking vendors of products within a products base, consumers of said products and affiliates having a business interest complementary to an industry of said products;
second accessing an affiliate platform associated with said e-commerce platform, wherein one of said steps of first accessing and second accessing comprises activating a link between said e-commerce platform and said affiliate platform; and
submitting product order information via said e-commerce platform, said product order information identifying for purchase one or more of said products from one or more of said linked vendors.

48. A social network for business-to-business method, comprising the steps of:
establishing an e-commerce platform in connection with a tiered vertical market defined by a specialty product space, said tiered vertical market space including vendors of specialty products within said product space, consumers of said specialty products and potential affiliates having a business interest complementary to an industry of said specialty products, wherein said e-commerce platform can be linked to affiliate platforms of said potential affiliates for electronic transfer of information between said e-commerce platform and said affiliate platforms, and said e-commerce platform can further be linked to vendor platforms of said potential vendors for electronic transfer of information between said e-commerce platform and said vendor platforms all participating within the social network for business-to-business platform;
obtaining, via said platform, consumer identification information and consumer location information regarding a consumer; and
using, at said e-commerce platform, said consumer location information to provide location-specific information to said consumer.

49. Asocial network for business-to-business apparatus, comprising:
an e-commerce platform for consolidating a tiered vertical market defined by a market space, said tiered vertical market including vendors or products of services within said market space, consumers of said products or services, and potential affiliates having a business interest complementary to an industry of said market space;
said e-commerce platform being operative for establishing links to affiliate platforms of said potential affiliates for electronic transfer of information between said e-commerce platform and said affiliate platforms and for establishing links to vendor platforms of said potential vendors for electronic transfer of information between said e-commerce platform and said vendor platforms;
an input port, associated with said e-commerce platform, for receiving an order, including order information from one of said consumers directed to said e-commerce platform via a referring affiliate platform, so the order information identifying for purchase one or more of said products or services from one or more of said vendors; and
an output port, associated with said e-commerce platform, for communicating with said referring affiliate platform and/or one or more said vendors in relation to fulfillment of said order.

50. An apparatus as set forth in claim 49, wherein said e-commerce platform is operative for providing content from said e-commerce platform to at least one of said affiliate platforms.

51. An apparatus as set forth in claim 49, wherein said e-commerce platform is further operative for receiving branding information from at least a first affiliate of said affiliate platforms.

52. An apparatus as set forth in claim 49, wherein said e-commerce platform is further operative for identifying, in connection with a visit by a consumer to said e-commerce platform, a referring affiliate associated with said visit.

53. An apparatus as set forth in claim 52, wherein said e-commerce platform is further operative for providing, in connection with said visit, branding information of said referring affiliate on a user interface of said e-commerce site.

54. An apparatus as set forth in claim 52, wherein said e-commerce platform is further operative for crediting an account of said referring affiliate in connection with said visit.

55. An apparatus as set forth in claim 49, wherein said e-commerce platform is operative for receiving multiple vendor product order information identifying products of a plurality of vendors.

56. An apparatus as set forth in claim 55, wherein said e-commerce platform is further operative for providing, in connection with said multiple vendor product order information, a single checkout process for purchasing said identified products or services of said multiple vendors.

57. An apparatus as set forth in claim 49, wherein said e-commerce platform is further operative for transmitting order information to one or more vendors in connection with said order.

58. An apparatus as set forth in claim 49, wherein said e-commerce platform is further operative for accessing product availability information in connection with said order.

59. An apparatus as set forth in claim 49, wherein said e-commerce platform is further operative for providing order status information to one or more consumers.

60. An apparatus as set forth in claim 49, wherein said e-commerce platform is operative for obtaining consumer identification information and consumer location information regarding consumers visiting said e-commerce platform.

61. A method as set forth in claim 60, wherein said e-commerce platform obtains said consumer identification information and said consumer location information by prompting users to enter said information.

62. An apparatus as set forth in claim 60, wherein said e-commerce platform is operative to use said consumer location information to provide location-specific information to consumers.
